(19) United States
(12) Patent Application Publication
(10) Pub. No.: US 2018/0133622 A1
(43) Pub. Date: May 17, 2018

(54) Thickener Feed Dilution System

(71) Applicant: Paterson & Cooke Ideas, Ltd., Golden, CO (US)

(72) Inventors: Michael A. Cook, Golden, CO (US); Christian Kujawa, Golden, CO (US)

(73) Assignee: Paterson & Cooke Ideas, Ltd., Golden, CO (US)

(21) Appl. No.: 15/815,474

(22) Filed: Nov. 16, 2017

Related U.S. Application Data
(60) Provisional application No. 62/423,591, filed on Nov. 17, 2016.

(51) Int. Cl. B01D 21/00; B01D 21/24

(52) U.S. Cl. CPC B01D 21/0024; B01D 21/34; B01D 21/2405; B01D 21/0018

(57) ABSTRACT

Dilution check valves, pumps, systems, and methods of use, useful for dilution of incoming feed into a feedwell or feed system that can be easily installed and removed on solid/liquid separation units. The feed dilution apparatuses or systems can be installed in a single location or in multiple locations around a feedwell, transferring supernatant drawn from single or multiple locations within a solid/liquid separation tank. Optionally, an in-line turbine style pump and/or downward draft configuration can be used to provide efficient pumping and accurate adjustment of volume by increasing or decreasing rotation speed. The feed dilution pumps can optionally be installed using a quick fit system that allows removal and replacement during operation without the need for mobile cranes or heavy lifting equipment.

### CROSS-REFERENCE TO RELATED APPLICATIONS

This application claims priority to and the benefit of the filing of U.S. Provisional Patent Application Ser. No. 62/423,591, entitled “Thickener Feed Dilution System”, filed on Nov. 17, 2016, and the specification and claims thereof are incorporated herein by reference.

### BACKGROUND OF THE INVENTION

### Field of the Invention (Technical Field)

Embodiments of the present invention relate to a check valve which attaches to dilution ports of a feedwell. More particularly, embodiments of the present invention relate to a check valve, or multiple check valves, which can permit the entry of supernatant liquid into the feedwell, but which can also close off to prevent the escape of liquids or solids from a feedwell when the pressure exerted on the valves by liquids and/or solids inside the feedwell is greater than the pressure exerted on the valves by liquids and/or solids outside of the feedwell. The dilution port and check valve may be used in other applications in addition to feedwells.

Embodiments of the present invention also relate to a forced feed dilution module that can be connected to a solid/liquid separation unit otherwise known as a thickener. More particularly, embodiments of the present invention relate to a controlled, variable output and efficient method of transferring supernatant liquid that is collected from within a solid/liquid separation unit, and then pumped into the feedwell or feed system for the purpose of diluting the incoming feed. Embodiments of the present invention can significantly enhance the efficiencies of flocculants and other reagents often used within the process as well as improve the settling rate, overflow clarity and underflow density. Embodiments also provide a method for controlling and/or enhancing mixing efficiency within the feedwell by increasing the velocities and energy. Embodiments of the present invention can be used and/or adapted for use in other applications in addition to feedwells, thickening, or solid/liquid separation processes.

### Description of Related Art

The majority of thickening applications require the incoming feed concentration to be diluted prior to, or within the feedwell itself. This has a significant effect on the mixing in the feedwell of the dilution stream with the feed stream, as well as the mixing of flocculant with the diluted feed stream, with impact on the efficiencies of flocculants used within the feedwell. The dilution before flocculation also improves the settling rate of flocculant/particle aggregates as well as improves the solid/liquid separation overflow clarity as well as underfloor density. Some systems accomplish this dilution with pumps (a forced dilution system), and others use various methods of taking advantage of the hydraulic head differential between the inside of the feedwell that receives and contains the higher density feed and the outside of the feedwell (thickener tank) that has the recovered water with a low density (a passive dilution system). Forced dilution is required when the density in the feedwell becomes low enough that insufficient driving head from outside to inside exists to ensure a high enough passive dilution flow. Forced dilution is also required when exceedingly high dilutions are required or additional mixing energy within the feedwell is required.

Many thickener systems use dilution ports or slots that are generally fitted around the outside of the feedwell. These systems typically use a floating flap or gate on the inside that closes if the level within the feedwell rises above that of the water outside. U.S. Pat. No. 5,147,556 describes one such system. Those systems, however, are expensive, often require adjustments for installation, and rely on mechanical hinges and/or pivoting mechanisms. Such systems, therefore, are not always reliable and require extensive maintenance.

There is thus a present need for a simple and comparatively inexpensive check valve for a dilution port of a feedwell (or other applications) which is simple, self-adjusting, and reliable to install and operate.

The majority of solid/liquid separation applications require the incoming feed to be diluted to a desired solids concentration that is required to achieve optimal performance. This process is usually performed within the feed system prior to the feed being introduced into the feedwell or, performed at the feed introduction position merging with the feed inlet pipe. Some systems achieve this dilution by utilizing external pumps and mixing sources of dilution water from outside of the thickener process. Other related systems utilize eductor systems to draw dilution water from one or two points in close proximity to the feedwell feed inlet, and merge the feed and dilution streams together prior to entry into the feedwell.

Many thickener applications use forced feed dilution systems that are generally fitted in one or two locations on the outside of the feedwell, with the dilution water being introduced directly or tangentially with the incoming feed stream. These systems typically use a vertically mounted lift pump to lift and transfer captured supernatant liquid into the feed stream. U.S. Pat. No. 7,520,995 describes one such system. Those systems, however, utilize a method which requires that the captured supernatant be lifted up into the feed stream. This lifting configuration thus requires more energy than would be required if the supernatant could instead be introduced horizontally or in a downward flow path. The lifting method that typically utilizes a vertical lift pump is often inefficient and limited in capacity due to its design. Such units are usually large, have a considerable mass, are expensive, and often require the operation to be shut down and the entire unit removed with a mobile crane for maintenance when such units fail, wear out, or experience a significant reduction in pumping efficiency. Known devices also allow solids to escape and flow back from the feedwell through the unit and out into the thickener tank. This is typically detrimental to the entire process and increases operating costs.

Many of the forced feed dilution systems, whether of the educator type or of the vertically mounted lift axial flow pump type, do not allow quantification of the dilution flow. Lack of direct measurement of the dilution flow prevents controlled dilution where a specific target solids concentration, which is optimum for the system, is achieved through either feed forward or feed backward control.

Many thickener applications use feed dilution systems that are generally fitted in one or two locations on the outside of the feedwell, with the dilution water being introduced directly or tangentially with the incoming feed stream. The non-distributed nature of these feed dilution systems results in localized up flow patterns within the solid/liquid separation unit. The localized flow patterns represent process inefficiency, in that the solid/liquid separation units typically are round in nature and therefore require radially equivalent flow patterns for proper performance. Localized flow patterns introduce short-circuiting, which can result in unequal distribution of feed to the unit or higher up flow rates and thus entrainment of particles to the overflow.

There is thus a present need for a more efficient inline or downward draft feed dilution module which is modular in design, has an adjustable volume capacity, is well distributed, easily removable, simple to maintain and operate, reliable, easy to install, and which is comparatively inexpensive. There is further a need for a unit that can be fitted in multiple positions around the perimeter of the feedwell to introduce supernatant at selected points for controlled feed dilution and for adjusting the mixing energy required to achieve mesomixing.

### BRIEF SUMMARY OF EMBODIMENTS OF THE PRESENT INVENTION

An embodiment of the present invention relates to a dilution port check valve having a valve housing, an inner bezel, an outer bezel, and a diaphragm, the diaphragm having at least one check valve disposed therein and the diaphragm disposed between the inner bezel and the outer bezel. The dilution port check valve can also include a plurality of check valves disposed in the diaphragm and each of the plurality of check valves can have an at least substantially rectangular shape. The dilution port check valve housing can have a shape that, when attached to a feedwell, causes fluid to enter the feedwell tangentially thereto. The diaphragm can be formed from a sheet of material. The diaphragm can comprise a flexible material. Optionally, the outer bezel can comprise at least one cross-piece. The outer bezel can have a plurality of cross-pieces. The dilution port check valve can include a dilution port mounting bracket. Optionally, the check valve can be arranged such that when the dilution port check valve is attached to a feedwell, supernatant liquid passing through the dilution port check valve is directed into the feedwell.

An embodiment of the present invention also relates to a dilution port check valve having a dilution port mounting bracket, a valve housing, an outer bezel—the outer bezel having one or more cross-pieces, and a diaphragm, the diaphragm having at least one check valve disposed therein and the diaphragm disposed between the valve housing and the outer bezel. The diaphragm can optionally comprise a polyurethane material, a rubber material, or a combination thereof. The check valve can be arranged such that when the dilution port check valve is attached to a feedwell, supernatant liquid passing through the dilution port check valve is directed into the feedwell.

An embodiment of the present invention also relates to a dilution port check valve having a valve housing, the valve housing attached to a feedwell, an outer bezel, the outer bezel having one or more cross-pieces, and a diaphragm, the diaphragm having at least one check valve disposed therein and the diaphragm disposed between the valve housing and the outer bezel. The dilution port check valve can also include an inner bezel. The diaphragm can have a plurality of check valves disposed therein. Optionally, the check valve can be arranged such that when the dilution port check valve is attached to a feedwell, supernatant liquid passing through the dilution port check valve is directed into the feedwell tangentially.

An embodiment of the present invention also relates to a method for automatically controlling entry of supernatant liquid into a feedwell, the method including providing a dilution port check valve to the feedwell, allowing one or more check valves of a diaphragm to swing inward toward a center of the feedwell to permit a flow of the supernatant liquid into the feedwell, and inhibiting supernatant liquid from flowing out of the feedwell by preventing the one or more check valves of the diaphragm from opening away from the feedwell by stopping them with one or more cross-pieces of an outer bezel. Optionally, providing a dilution port check valve to the feedwell can include attaching a dilution port check valve to the feedwell with a bracket.

An embodiment of the present invention also relates to a feed dilution pump which can comprise a vertical axis pump, an inlet of the vertical axis pump disposed above an impeller, an outlet of the vertical axis pump communicably coupled to an internal area of a feedwell, and the vertical axis pump configured and disposed so that it moves supernatant liquid from a thickener tank to the feedwell without lifting the supernatant liquid. In one embodiment, the feed dilution pump does not have an inlet below the impeller. The feed dilution pump can include a motor communicably coupled to the impeller and the motor can be disposed above a waterline of the thickener tank. Optionally, a check valve can be disposed in fluid communication with the vertical axis pump at a location between the impeller and the internal area of the feedwell or the check valve can be disposed in fluid communication with the check valve before the impeller. The outlet of the vertical axis pump can be coupled to a pipe that is connected to a feedwell. The vertical axis pump can have a direct current powered motor. Optionally, at least one vortex-breaking fin can be disposed radially above the impeller. The feed dilution pump can further include a cone disposed above the impeller through which a shaft of the pump passes.

An embodiment of the present invention also relates to a feed dilution pump having a horizontal axis pump, an inlet of the horizontal axis pump disposed within a thickener tank, an outlet of the horizontal axis pump communicably coupled to an internal area of a feedwell, and the horizontal axis pump configured and disposed so that it moves supernatant liquid from a thickener tank to the feedwell without lifting the supernatant liquid more than six inches. The feed dilution pump can also include a check valve disposed in fluid communication with the horizontal axis pump at a location between an impeller and the internal area of the feedwell or on an inlet side of an impeller of the feed dilution pump. The outlet of the horizontal axis pump can be coupled to a pipe that can be connected to a feedwell. The feed dilution pump can also include a direct current powered motor, and the motor can be sealed and directly coupled to an impeller of the feed dilution pump.

An embodiment of the present invention also relates to a feed dilution system having a feedwell, a plurality of feed dilution pumps, the plurality of feed dilution pumps arranged such that outflow from each feed dilution pump enters the feedwell at least substantially tangentially thereto or at substantially a right angle thereto, and the plurality of feed dilution pumps can be configured around the feedwell to provide feed dilution equally around a circumference of the feedwell. The feed dilution system can also include a pipe or chute disposed between each of the feed dilution pumps and the feedwell. Optionally, the feed dilution pumps can be attached to the feedwell via sliding brackets. In one embodiment, the feed dilution system can also include a launder disposed at least partially around the feedwell, and the launder can optionally have an open top. The launder can have a plurality of openings on an outer-circumference side thereof. In one embodiment, the launder can have a plurality of openings on a bottom side thereof. In one embodiment, mixing energy of the feedwell can be adjusted by adjusting the speed of one or more of the feed dilution pumps. The outlet of the dilution pumps can optionally be injected below the level of the incoming feed to ensure efficient mixing and solids contact is achieved.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention arid are not to be construed as limiting the invention. In the drawings:

FIGS. 1 and 2 are drawings that respectively illustrate an elevated view and a cut-away side view of a typical dilution port with a check valve implementation, according to an embodiment of the present invention, which is attached to a feedwell and disposed within a thickener tank;

FIGS. 3 and 4 are drawings which respectively illustrate an elevated side view and a top view of a feedwell with dilution ports and multiple check valves according to an embodiment of the present invention;

FIGS. 5 and 6 are drawings which respectively illustrate a feedwell having multiple check valves as part of dilution ports of a feedwell according to an embodiment of the present invention;

FIGS. 7 and 8 respectively illustrate exploded-view drawings of multiple check valves from elevated front and elevated back views according to an embodiment of the present invention;

FIG. 9 is a drawing which illustrates a check valve diaphragm for a multitude of adjacent check valves according to an embodiment of the present invention;

FIG. 10 illustrates a check valve set mounted in a dilution port and in an open configuration with directional lines to indicate liquid flow direction;

FIG. 11 is a drawing which illustrates a check valve set in a closed position with directional lines to indicate force exerted by liquids that are unable to flow through the valve;

FIG. 12A illustrates an elevated side view of the dilution port and multiple check valves attached to a feedwell with directional arrows to indicate the flow of liquids into the feedwell;

FIG. 12B illustrates a diaphragm with a check valve formed therein;

FIG. 12C illustrates an elevated top view of a single check valve attached to a dilution port with directional arrows to indicate the flow of liquids into the feedwell;

FIG. 12D illustrates a top view of multiple dilution ports mounted in a feedwell with baffles fitted to the inside flow area that promote efficient dilution and prevent turbulence;

FIG. 12E illustrates an elevated view of a dilution launder assembly fitted with dilution ports on the inner ring and holes or slots, referred to as openings, placed in the launder floor to allow the inflow of supernatant and the draining of any collected solids;

FIG. 12F illustrates a side view of a dilution launder assembly fitted with dilution ports on the outer ring to allow the inflow of supernatant to the launder body;

FIGS. 13A and 13B are drawings which respectively illustrate front and rear views of an embodiment of a check valve having a circular configuration;

FIGS. 14A and 14B respectively illustrate a sectional side view of a horizontal axis pump and a partially-exploded view of a horizontal axis pump according to an embodiment of the present invention;

FIGS. 14C and 14D are drawings which respectively illustrate a side view of a horizontal axis feed dilution pump and a feedwell having a plurality of horizontal axis feed dilution pumps and openings in the lower launder floor disposed around a circumference thereof;

FIGS. 14E and 14F are drawings which respectively illustrate a sectional side view and an elevated perspective view of a launder on the outside of the feedwell according to an embodiment of the present invention; the launder collects dilution liquid, typically supernatant, in a radially flow equivalent manner; the launder can have a plurality of overflow weirs or constitute a single weir;

FIGS. 15A and 15B are drawings which respectively illustrate a side view of a vertical axis feed dilution pump that draws from both above and below an impeller and a top view of a feedwell having a plurality of such vertical axis feed dilution pumps disposed around a circumference thereof;

FIGS. 16A and 16B are drawings which respectively illustrate a side view of a vertical axis feed dilution pump that draws from above an impeller and a top view of a feedwell having a plurality of such vertical axis feed dilution pumps disposed around a circumference thereof;

FIGS. 17A, 17B and 17C are drawings which respectively illustrate a side view of vertical axis feed dilution pumps that draw supernatant from above an impeller with and without a check valve communicably coupled thereto either before or after the impeller;

FIG. 18 is a side view drawing of a vertical axis feed dilution pump alternative to the those of FIGS. 17A, 17B, and 17C, that draws from above an impeller and which is communicably coupled to an output thereof through a u-bend;

FIGS. 19 and 20 are drawings which illustrate side views of a vertical axis feed dilution pump installed in its operating position atop an induction body and with an induction cone and vortex breakers attached thereto;

FIG. 21 is an exploded-view drawing of a vertical axis feed dilution pump with an induction cone and vortex breaker and an induction body; and

FIGS. 22 and 23 are cut-away drawings which illustrate an impeller beneath an induction cone and vortex breakers for a vertical axis feed dilution pump attached to an induction body.

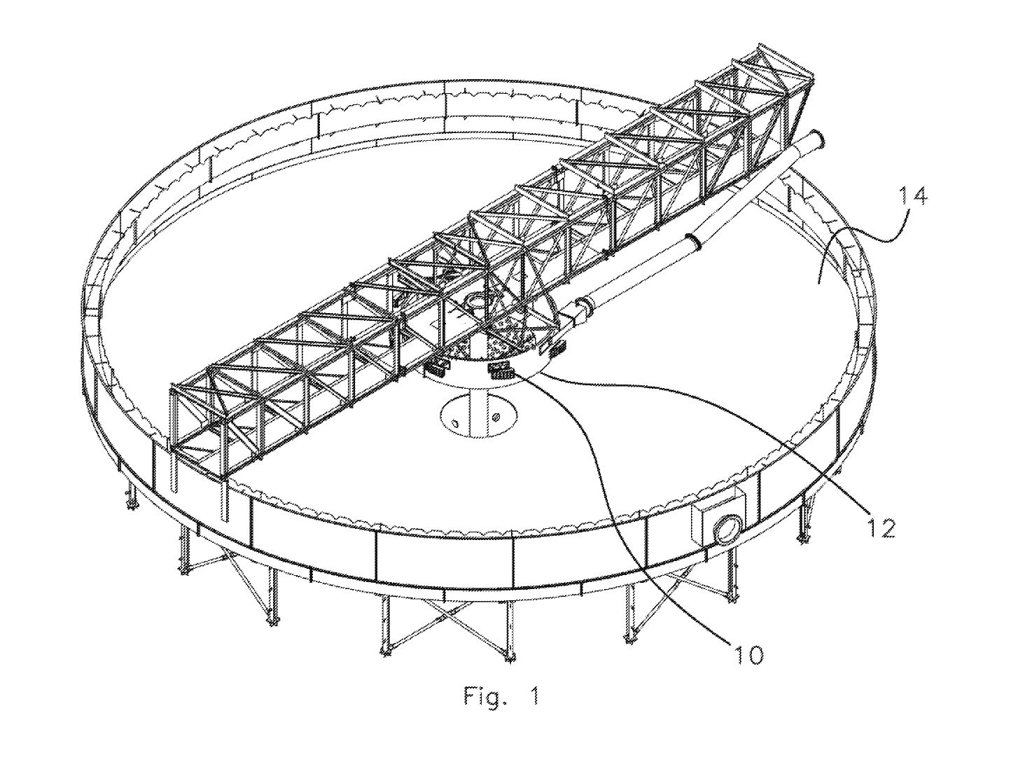

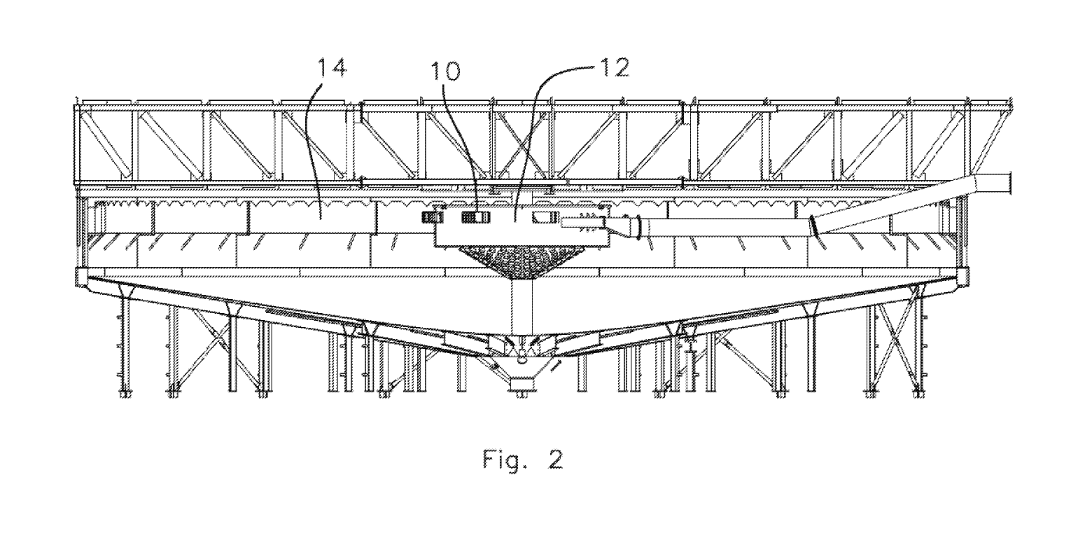

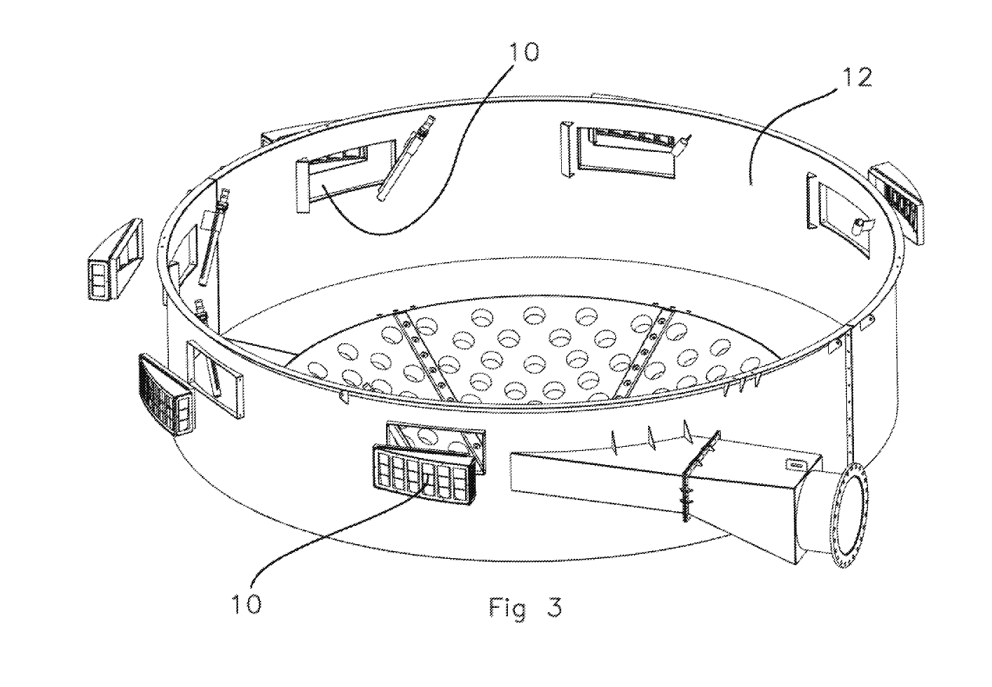

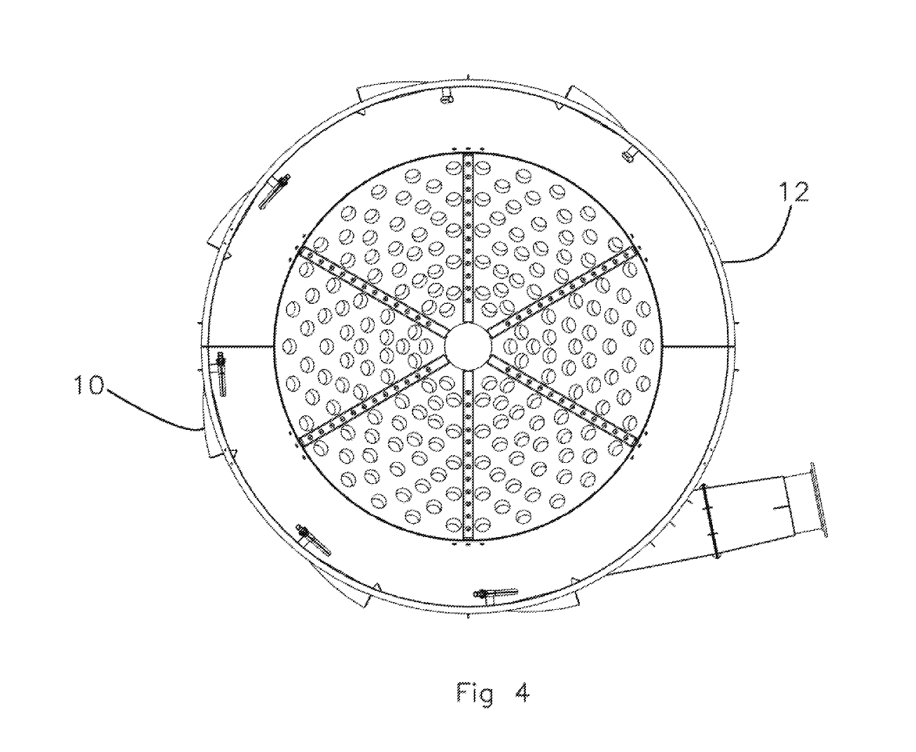

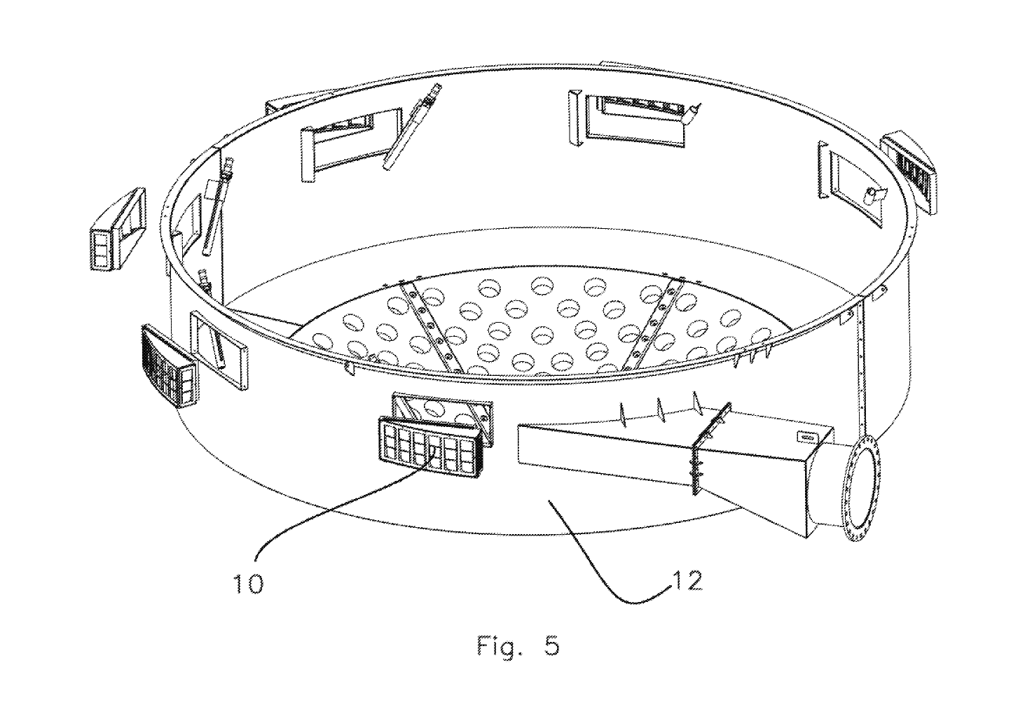

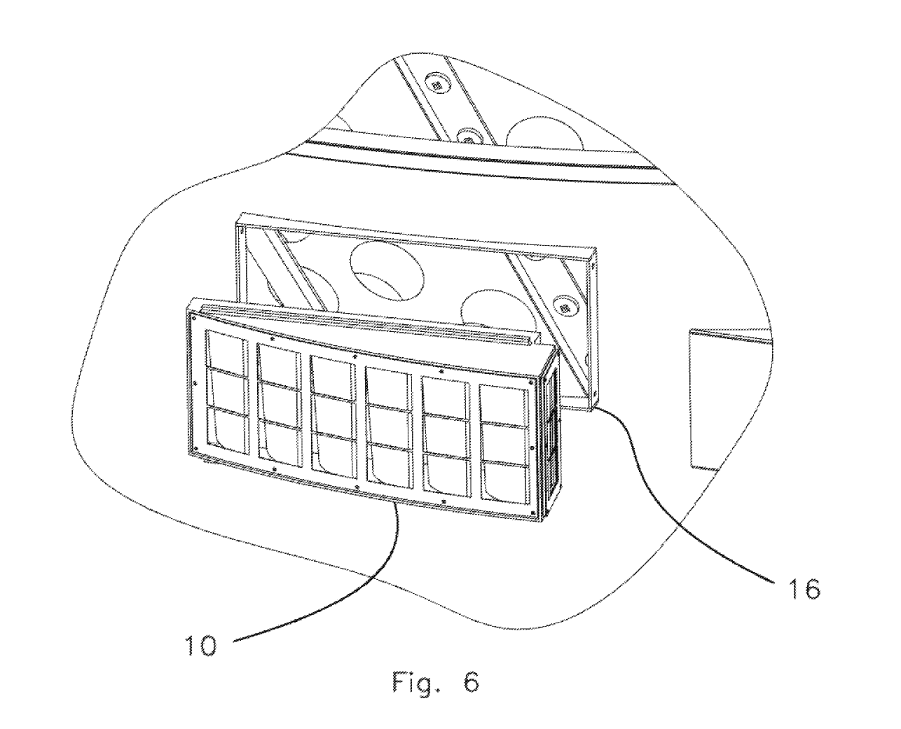

### DETAILED DESCRIPTION OF THE INVENTION

Although the specification describes a dilution port and check valve invention particularly useful for feedwell applications, it can be used in other applications wherein such a check valve may be useful. The term “cuts” as used throughout this application is not intended to be limited to only those cuts that are formed by physically cutting a material. Instead, the term “cuts” as used throughout this application is intended to include any voids formed or otherwise provided in a material, including but not limited to voids formed by using a mold that provides one or more voids or openings in a formed material.

Although the application discusses the use of embodiments in conjunction with a “thickener tank” the utility of aspects of the invention are not so limited. Thus, the term “thickener tank” is intended to include solids/liquids separation units including but not limited to thickeners and clarifiers. Although the term “impeller” is used throughout this application, the term is used for simplicity and is intended to include any apparatus that can move a liquid, including but not limited to both positive displacement and non-positive displacement pumps including but not limited to impellers, propellers, piston pumps, gear pumps, roller pumps, vane pumps, peristaltic pumps, turbines, combinations thereof, and the like.

Throughout this application, the term “waterline” is intended to mean a liquid-gas interface, including but not limited to a top surface of a supernatant liquid.

Referring now to the drawings, dilution port 10 and check valves 11 are preferably connected to feedwell 12 around, about, within, or otherwise in fluid communication with dilution ports 10 of feedwell 12. Most preferably, dilution ports 10 and check valves 11 are arranged tangentially around feedwell 12. Dilution ports 10 and check valves 11 are preferably disposed such that supernatant liquids within thickener tank 14 can enter feedwell 12 when feedwell 12 is capable of receiving such liquids. And, dilution ports 10 and check valves 11 permit liquids to flow into feedwell 12, while also inhibiting liquid with or without solids from flowing out of feedwell 12 and into thickener tank 14. Mounting bracket 16 can be integrally formed onto feedwell 12 or it can optionally be attached to feedwell 12 as a separate structure.

Mounting bracket 16 preferably has a shape and size which receives or otherwise connects to check valves 11. For example, in one embodiment, a plurality of holes can be arranged around mounting bracket 16; check valves 11 can comprise holes which align therewith, thus permitting dilution ports 10 and check valves 11 to be bolted or otherwise secured to bracket 16 and thus feedwell 12. Of course, tabs, snap locks, pins, welding, or any other method or apparatus or combination thereof can be used to connect dilution ports 10 and check valves 11 to bracket 16. In a preferred embodiment, bracket 16 is easily removable from feedwell 12.

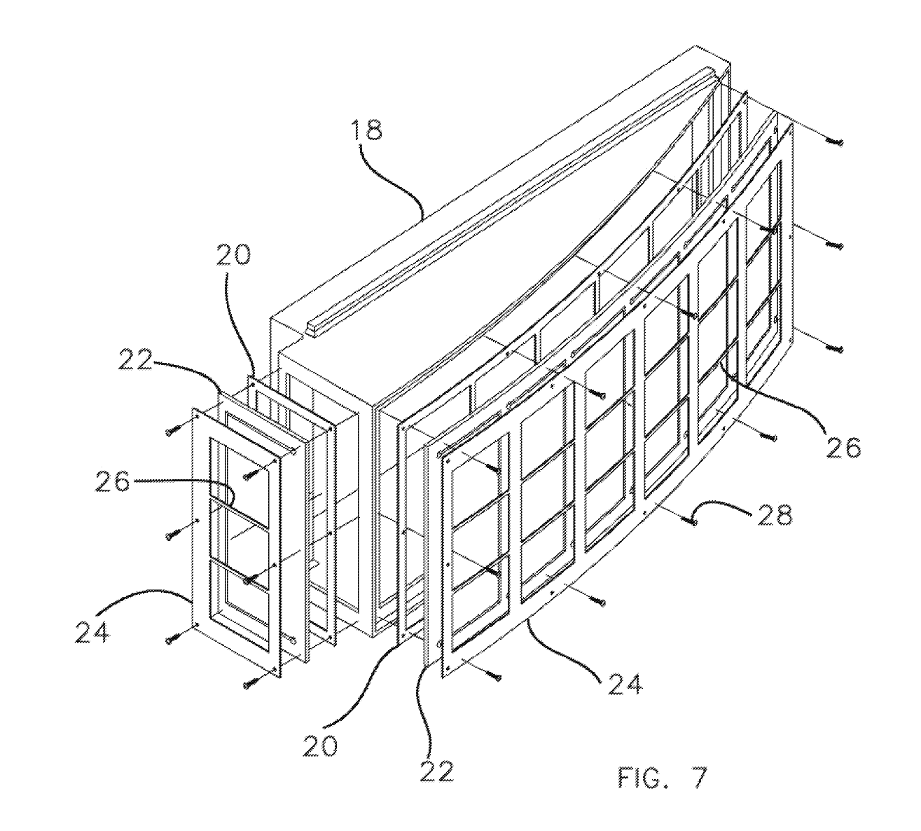

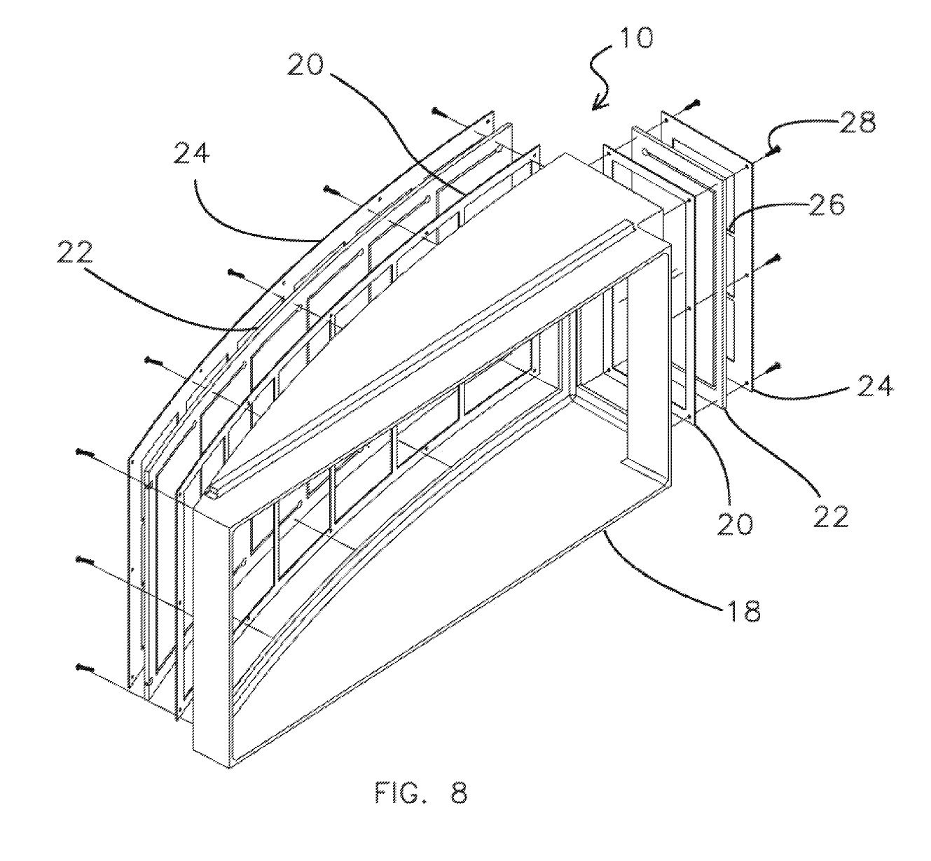

As best illustrated in FIGS. 7 and 8, dilution port 10 is preferably formed from housing 18, to which inner bezel 20, valve diaphragm 22, and outer bezel 24 attach using fasteners 28 of a suitable design and material. Outer bezel 24 preferably comprises one or more cross-pieces 26. In one embodiment, inner bezel 20 can be integrally formed into housing 18, for example by providing a wide area of material around one or more openings.

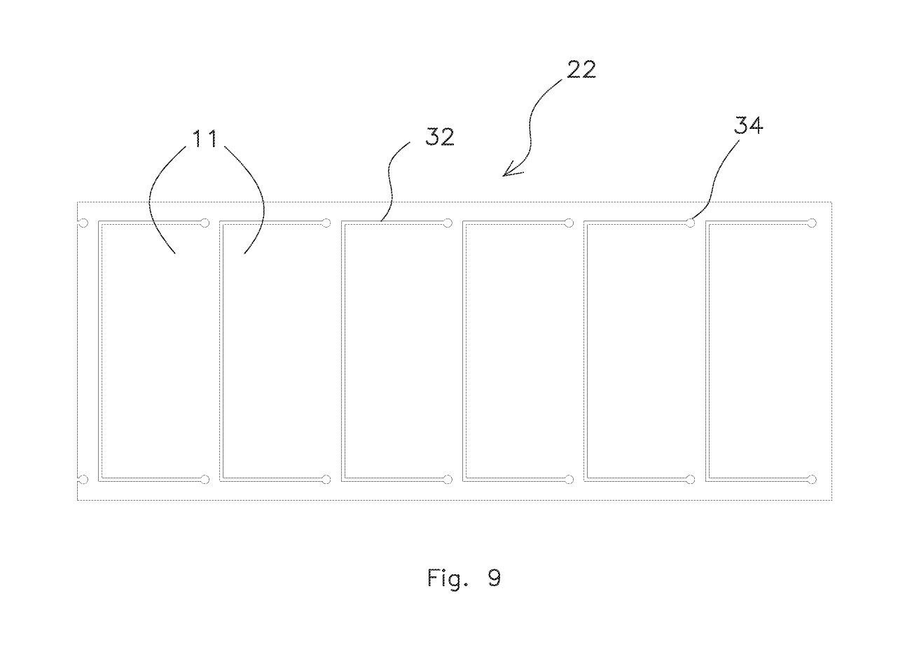

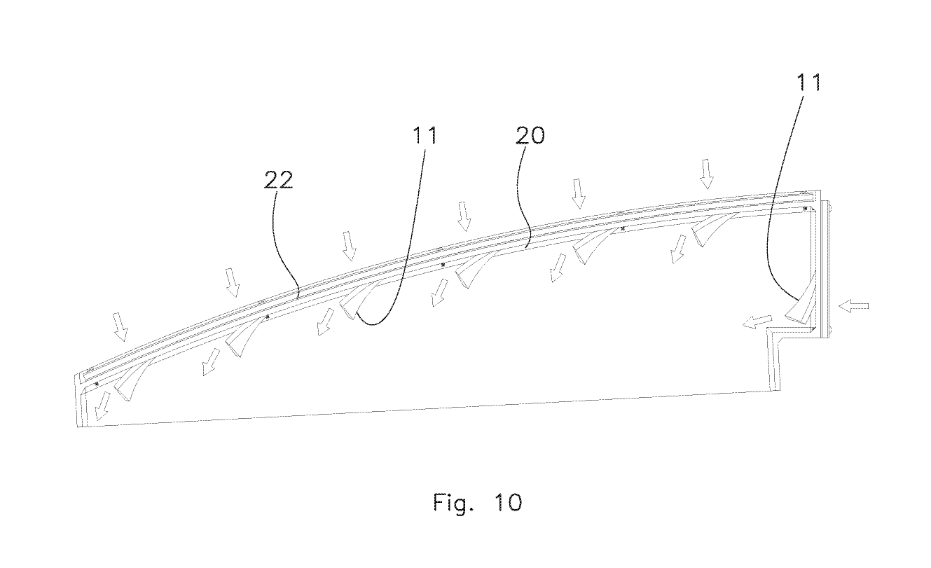

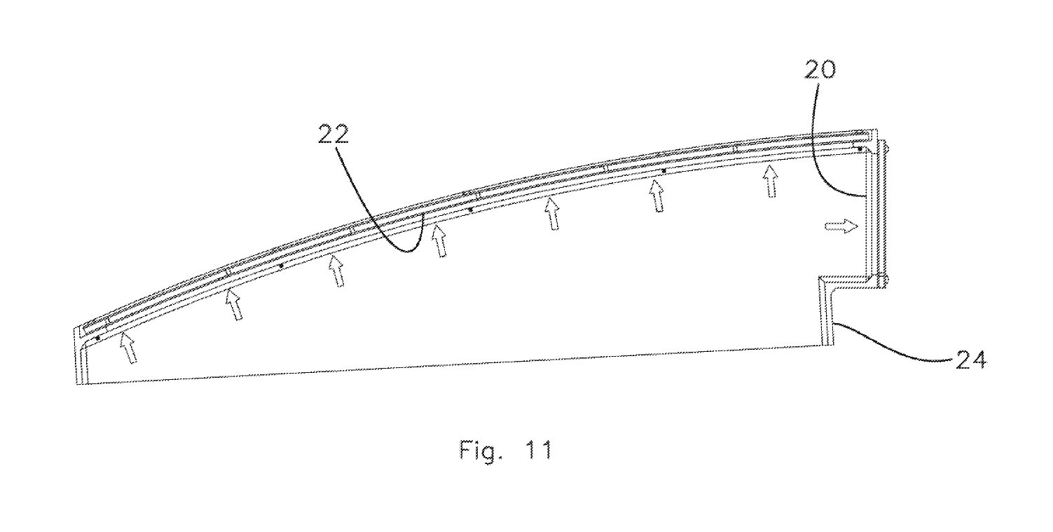

Valve diaphragm 22 preferably comprises a sheet or plate of plastic or elastomeric material, which can optionally include but is not limited to polyurethane or rubber. As best illustrated in FIG. 9, valve diaphragm 22 preferably comprises a plurality of check valves 11 formed therein by providing cuts 32 arranged such that at least a portion of each of check valves 11 remain attached to the rest of diaphragm 22; thus permitting check valves 11 to bend away from the rest of diaphragm 22 along the area where check valves 11 remain connected to the rest of diaphragm 22 by using fasteners 28. Although not essential, a plurality of tension relief holes 34 can also be disposed in diaphragm 22 to provide flexibility and movement for check valve 11. Although FIG. 9 illustrates an embodiment wherein diaphragm 22 has substantially rectangular check valves 11 formed therein by providing cuts 32 around three sides of a rectangle, an almost infinite number of other shapes and sizes of check valves 11 can be formed by making various cuts 32. For example, in one embodiment, a half-circle shaped cut or a V-shaped cut can instead be made to provide a curved check valve or a triangular-shaped check valve respectively. Further, although check valves 11 are illustrated in FIG. 9 as all being of the same shape and size and spaced equidistant from one another, embodiments of the present invention can provide desirable results when different shapes, sizes, spacing, and/or numbers of check valves 11 are formed in diaphragm 22 aside from that illustrated in FIG. 9.

In operation, flow of liquids from outside of feedwell 12 through check valve 11 is permitted because check valves 11 in diaphragm 22 are able to bend toward the center of feedwell 12, thus providing an open path through check valve 11. If liquid or solids attempts to flow from within feedwell 12 out through check valves 11, check valves 11 are preferably held in a closed position by cross-pieces 26 in outer bezel 24. Although the figures illustrate an embodiment wherein several cross-pieces 26 are provided across each location of a check valve 11, any number of cross-pieces 26 can be provided. In addition, the shape and location of cross pieces 26 are not essential, as long as check valves 11 are allowed to open in one direction and not in the opposite direction. For example, outer bezel 24 can optionally comprise a perforated structure having numerous round openings formed therein and the material of outer bezel 24 which forms each round opening would thereby form a plurality of cross pieces 26.

Although check valve 11 can be used to allow only inflow into the feedwell on the upper or lower part of the feedwell, the same type of check valve 11 can optionally be positioned in an opposite-facing direction and thus used to ensure only outflow of either liquids or solids on a lower or bottom portion of the feedwell.

Because feedwells are typically round and because the incoming feed stream is typically inserted tangentially into the feedwell, the contents of the feedwell are typically circulating in either a clockwise or counterclockwise direction. By forming dilution ports 10 in a wedge shape such that the rotating fluid first passes the wide portion of the wedge, a venturi-effect is formed, thus helping to draw supernatant liquid through check valves 11 from thickener tank 14. In one embodiment, a sheet of material, such as sheet metal, polyurethane, plastic, or rubber can be disposed inside of feedwell 12 to close off the dilution port to which one or more check valves 11 are coupled. In one embodiment, check valves 11 and diaphragm 22 are preferably disposed such that when open and allowing supernatant to enter the feedwell, the fluid passing through the openings enters the feedwell preferentially tangentially.

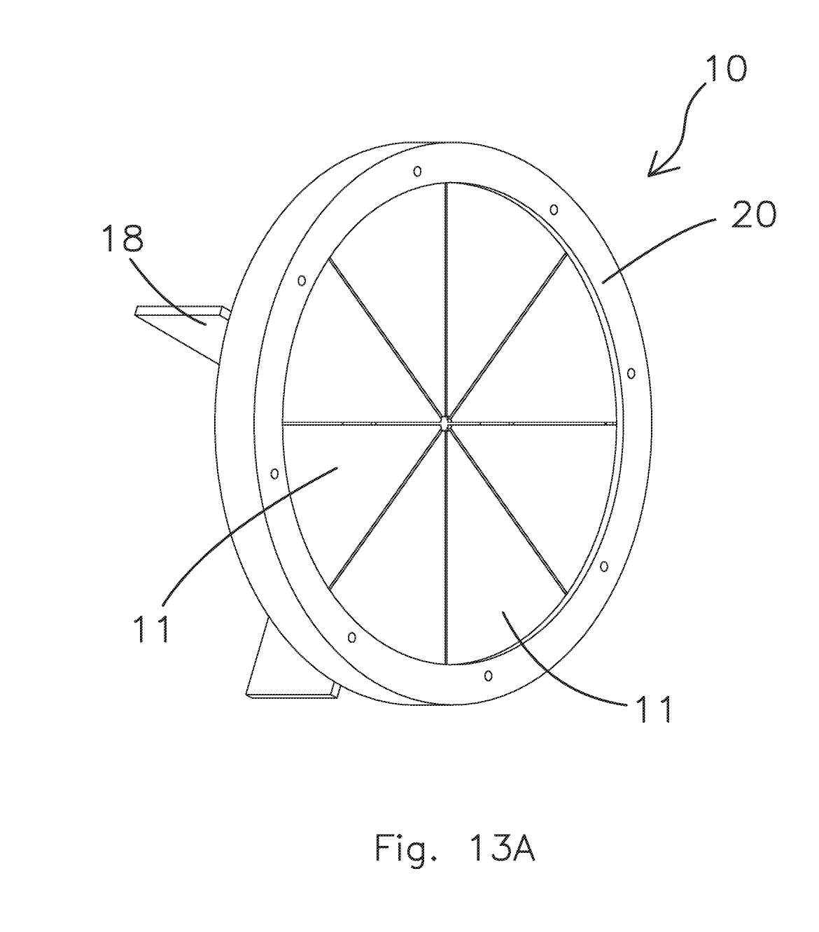

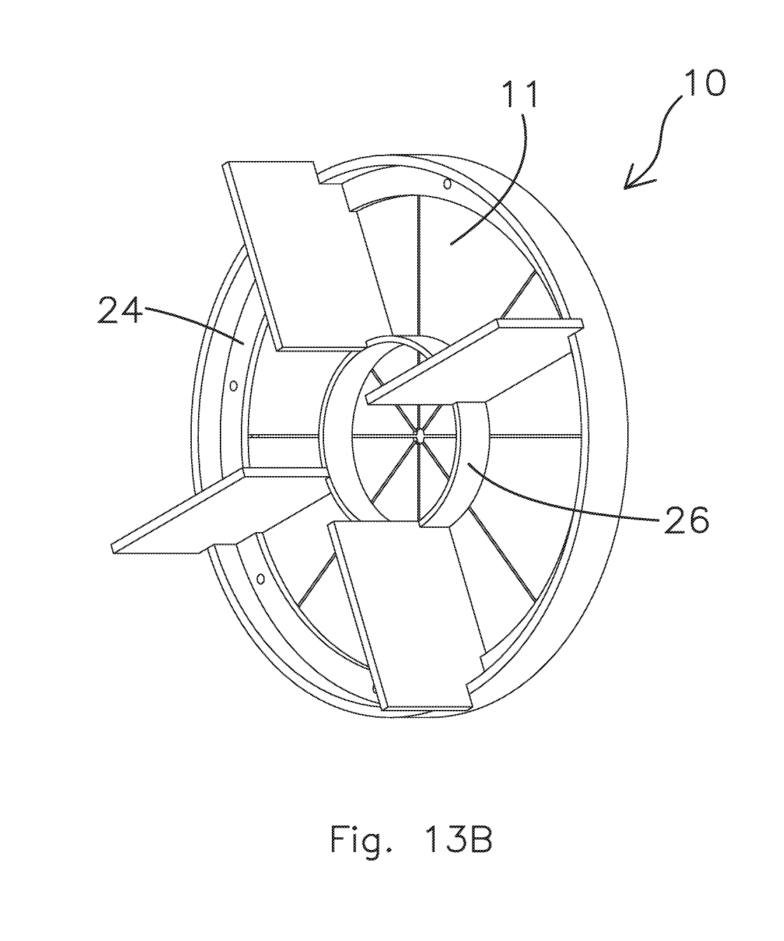

As best illustrated in FIGS. 13A and 13B, check valves 11 can comprise any desirable shape for a particular application—including a circular, triangular, square or rectangular shape. In this embodiment, housing 18 can have a generally circular shape. In one embodiment, inner bezel 20 and/or outer bezel 24 can optionally be permanently attached, or otherwise formed into housing 18. For example, in one embodiment, outer bezel 24 and dilution port housing 18 can be formed from a single cast, molded, or milled component. In an alternative embodiment, inner bezel 20 and dilution port housing 18 can be formed from a single cast, molded, or milled component. As with foregoing embodiments of check valves 11, diaphragm 22 preferably comprises one or more check valves 11 which can bend inward toward or through inner bezel 20 but which cannot bend in an opposite direction because they are stopped by cross-piece 26 of outer bezel 24. Another embodiment of check valves 11, is an alternative diaphragm design in which one or more check valves 11 which can bend outward toward or through inner bezel 20 cannot bend in an opposite direction because they are stopped by cross-piece 26 of outer bezel 24.

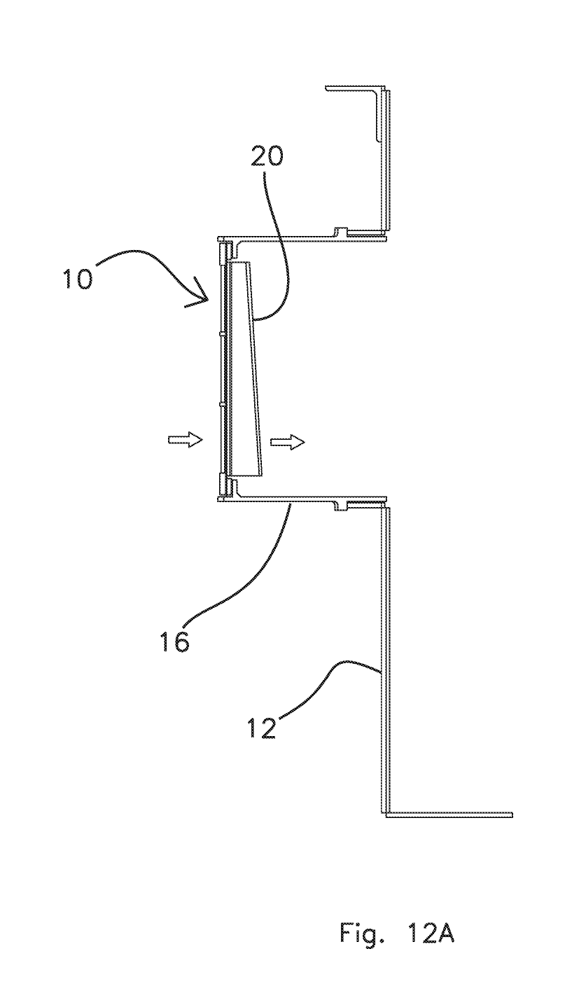

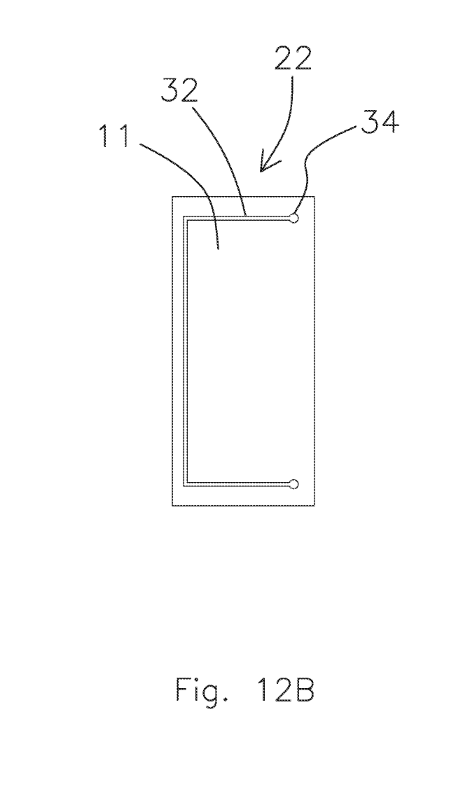

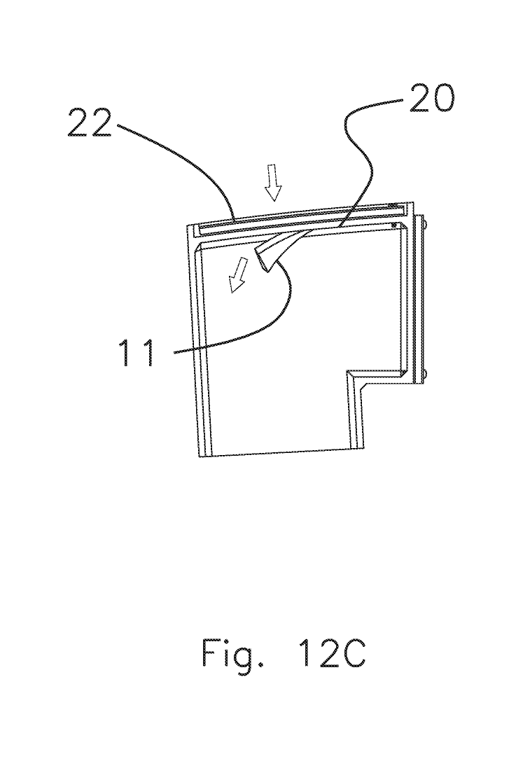

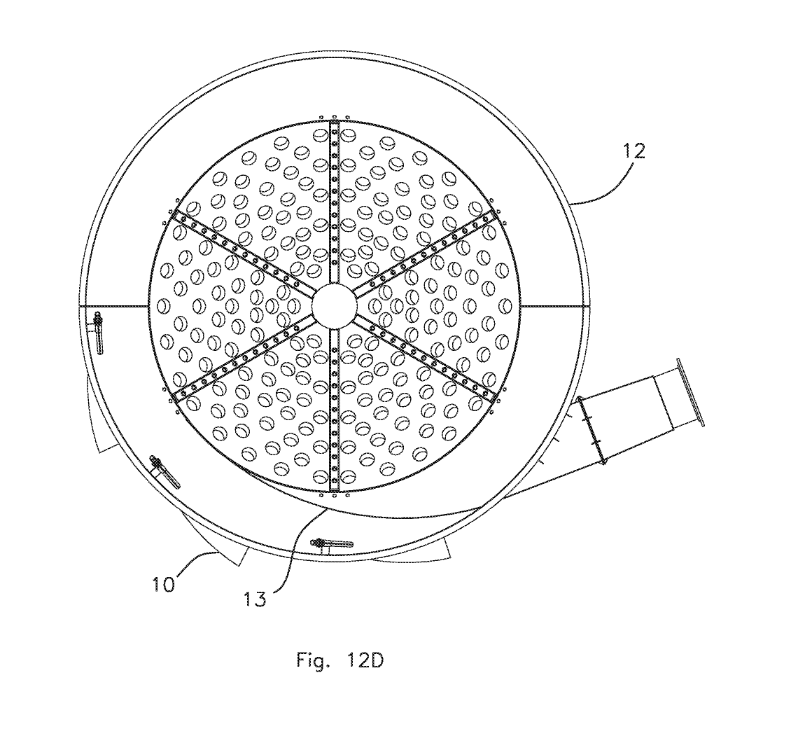

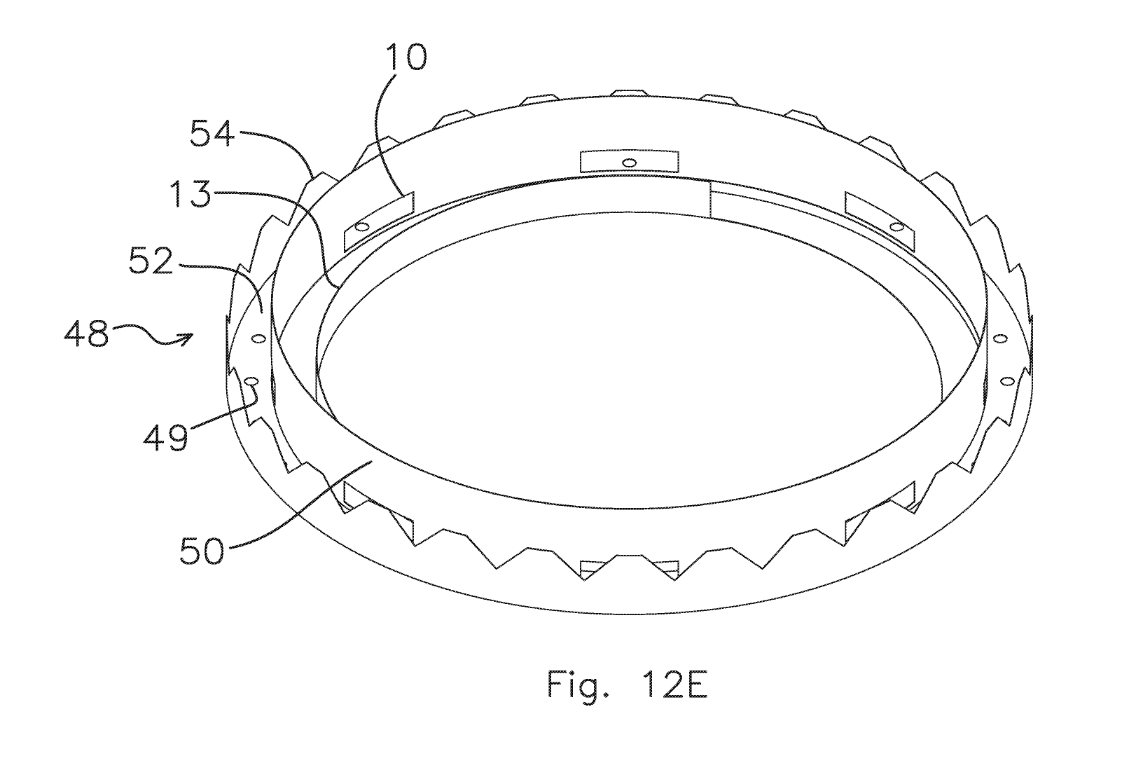

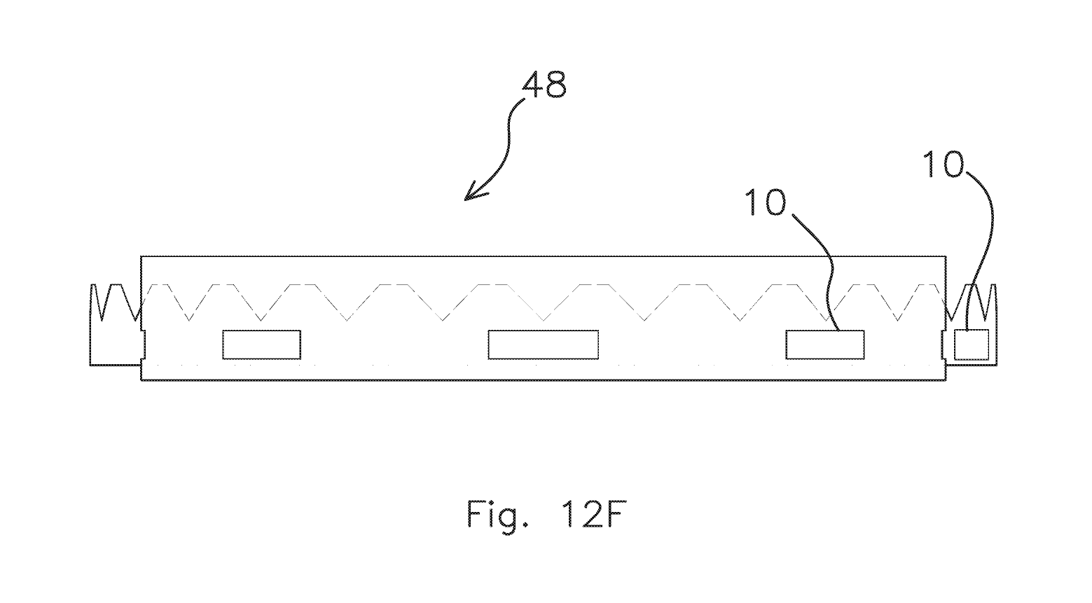

As best illustrated in FIGS. 12D and 12E, in one embodiment, vertical baffling 13, which can be formed from virtually any material, is preferably positioned inside feedwell 12 such that it deflects infeed away from a nearest dilution port 10, thus promoting the induction of dilution through that dilution port and minimizing any turbulence that may cause a disruption of flow or an uneven response of the accompanying valve 11 for that dilution port. Baffling 13 is preferably connected to wall 50 at or near where the feed enters. Baffling 13 preferably guides the feed away from dilution port 10. Baffling 13 can be supported towards the center of feedwell 12 in several locations—optionally with brackets, and can continue part way of the inner circumference of feedwell 12 or the full inner circumference of feedwell 12.

As best illustrated in FIGS. 12E and 12F, in one embodiment any number of dilution ports 10 and check valves 11 can be installed on inner plate 50 or outer plate 54 sections of the collection launder 48. In one embodiment, any number of openings 49 are placed in horizontal plate 52 of collection launder 48 to allow the inflow of supernatant and the draining of any collected solids. Openings in an embodiment of the present invention can also be utilized in this configuration to increase the volume of supernatant inflow.

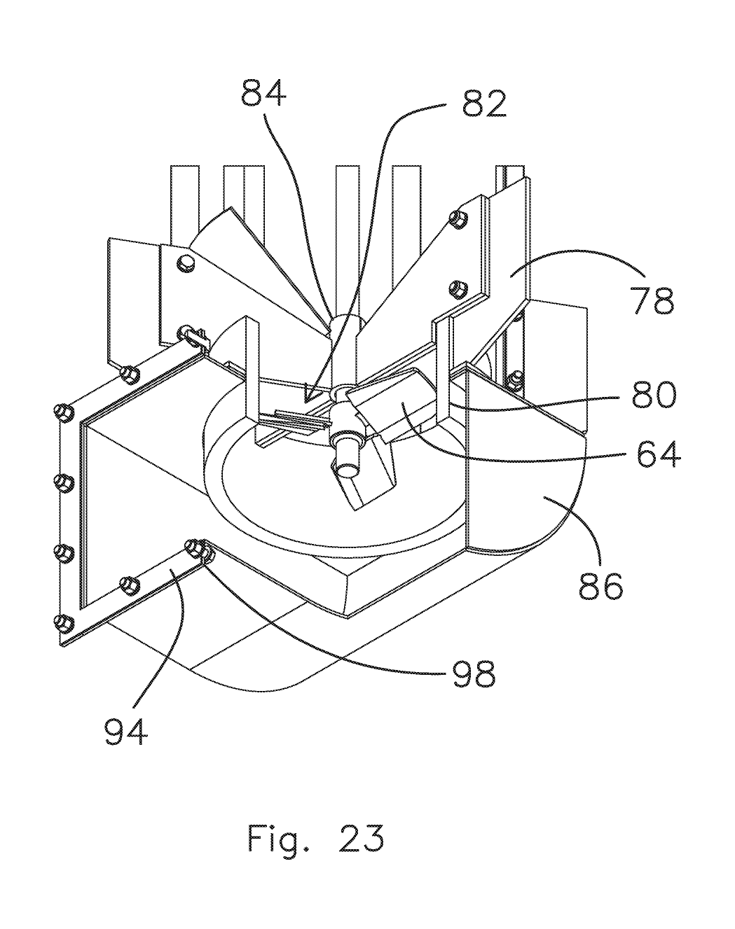

An embodiment of the present invention also relates to one or more feed dilution pumps 40 which are preferably connected to feedwell 12, most preferably feeding the feedwell tangentially. However, this orientation is not essential to the operation of the invention. Desirable results can be achieved by connecting feed dilution pumps 40 around, about, within, or otherwise in fluid communication with feedwell 12. Feed dilution pumps 40 are preferably disposed such that supernatant liquids within thickener tank 14 can be transferred to feedwell 12 when feedwell 12 is capable of receiving such liquids. Feed dilution pumps 40 preferably cause liquids to flow into feedwell 12, while also inhibiting solids from flowing out of feedwell 12 and into thickener tank 14. Mounting bracket 16 can be integrally formed onto feedwell 12 or it can optionally be attached to feedwell 12 as a separate structure. In one embodiment, mounting bracket 16 can have a tubular shape with a mounting flange. Optionally, mounting bracket 16 can comprise a length of pipe or tubing extending from an upper side-wall of feedwell 12—most preferably tangentially thereto, but again, this is not essential. In one embodiment, feed dilution pumps 40 can also draw froth from the top of thickener tank 14. In this embodiment, impeller 64 (see FIG. 23) preferably not only draws such froth and/or supernatant liquid in, but can also shear the froth and dissipate air bubbles within any froth that is drawn in.

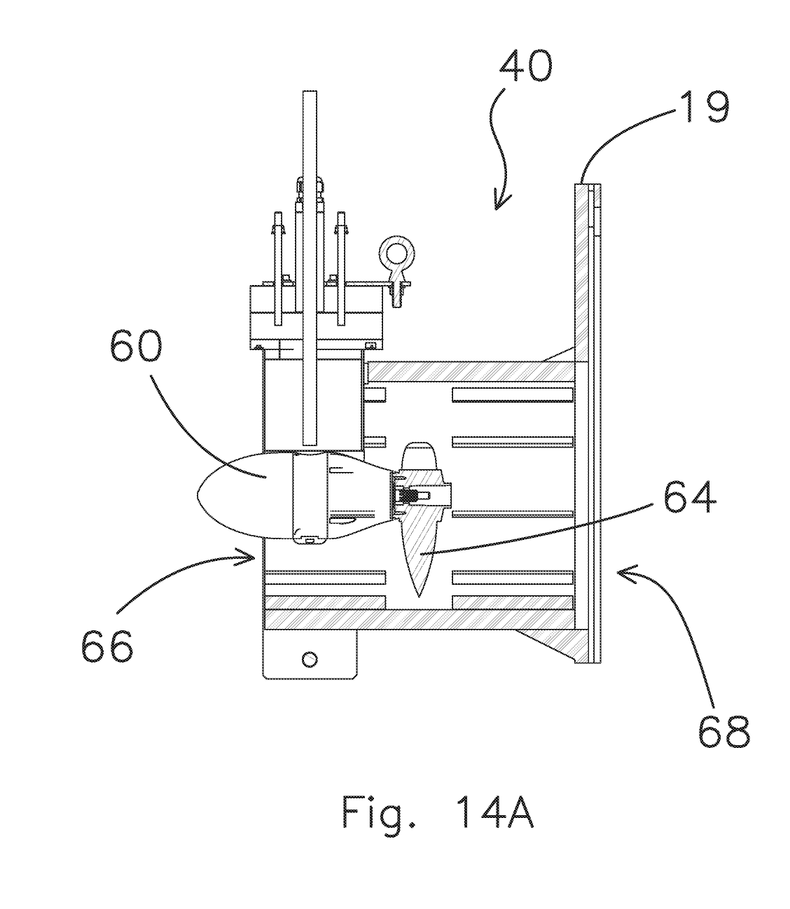

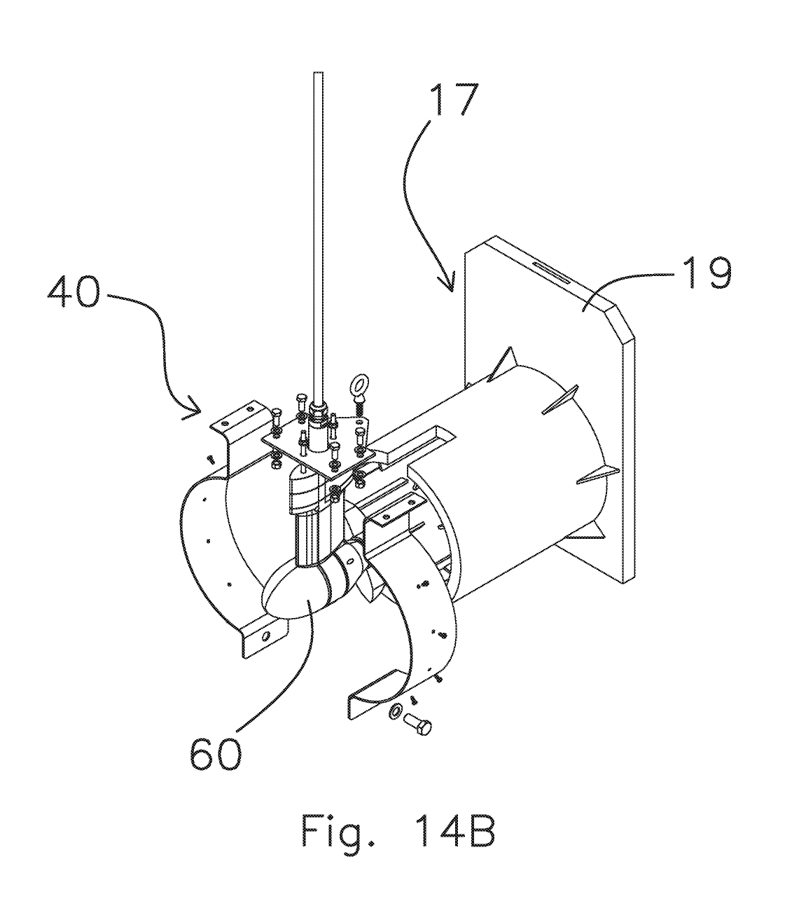

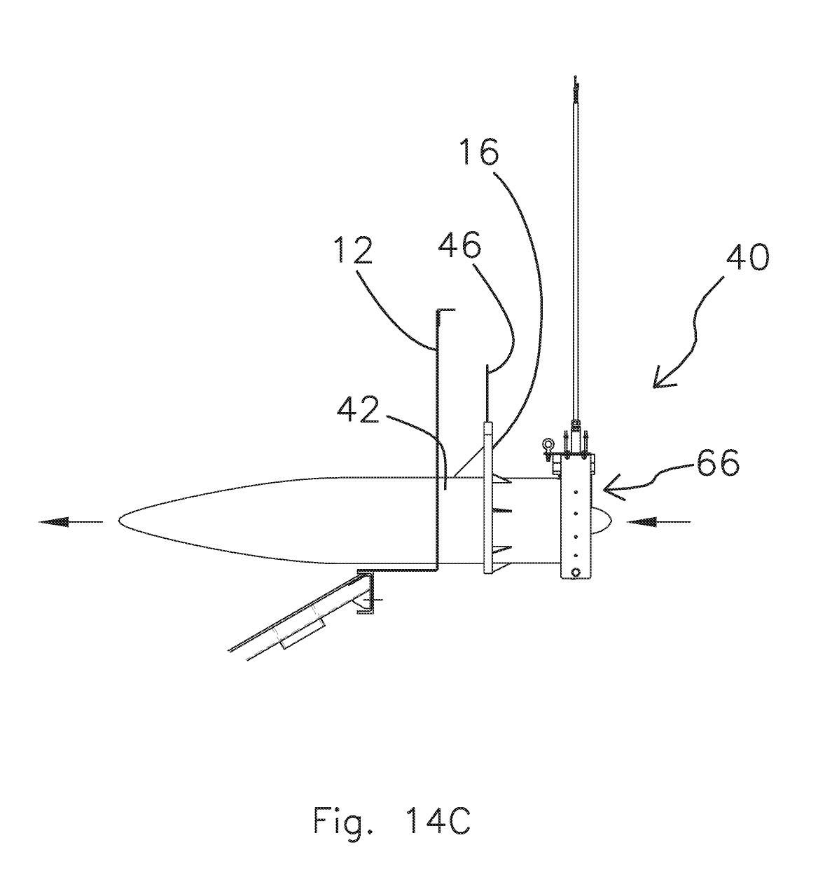

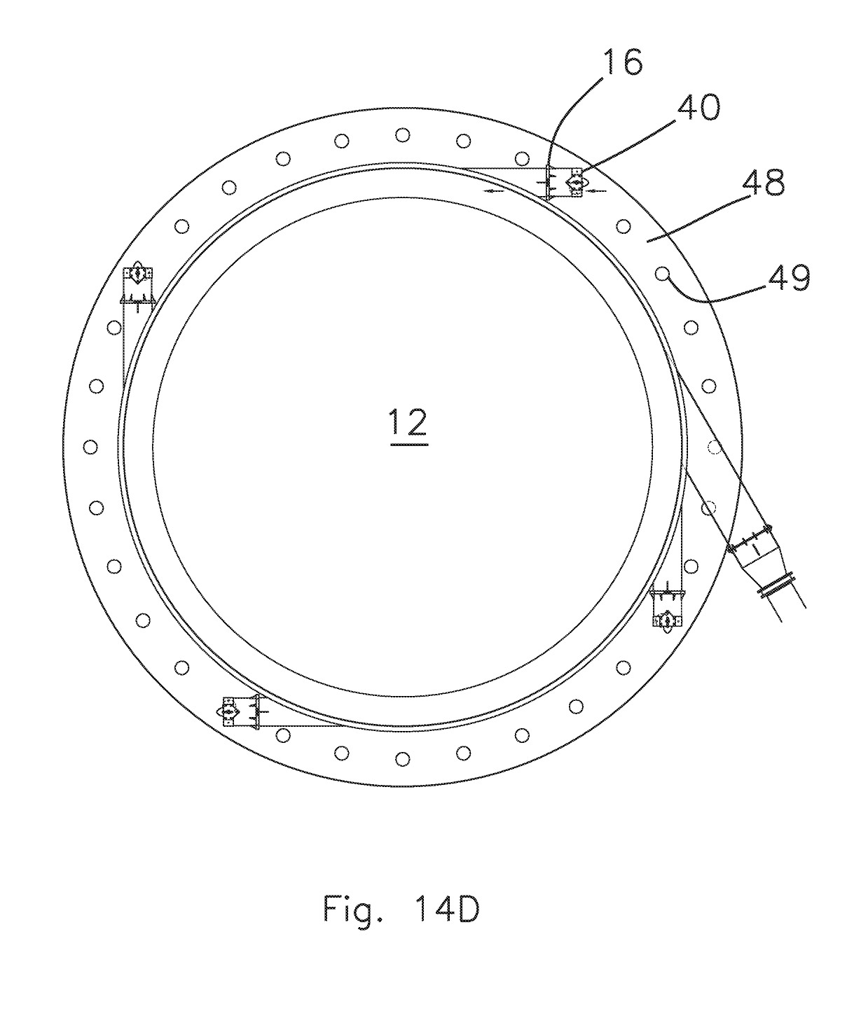

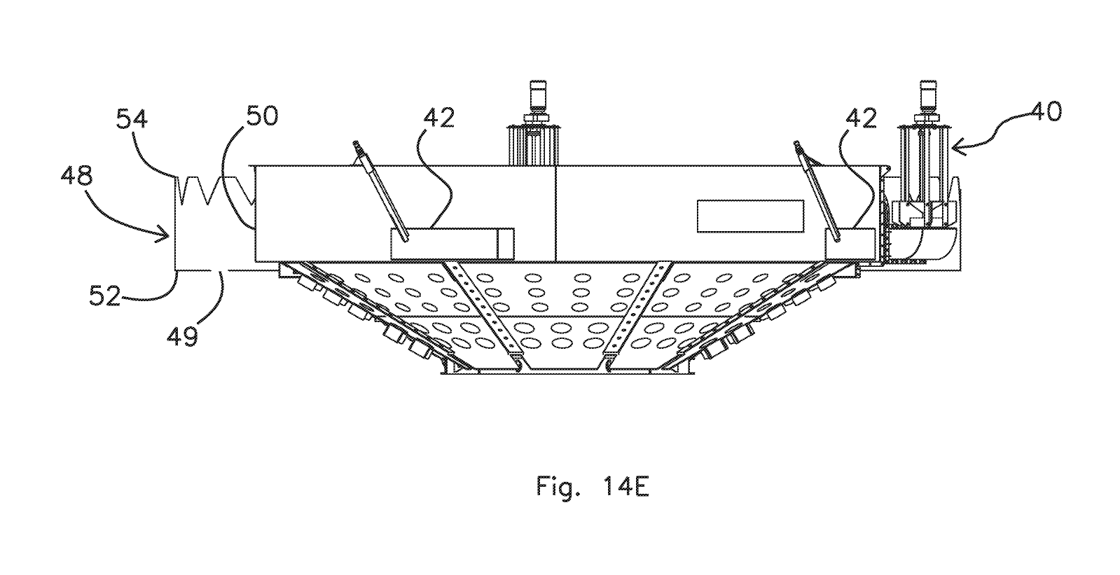

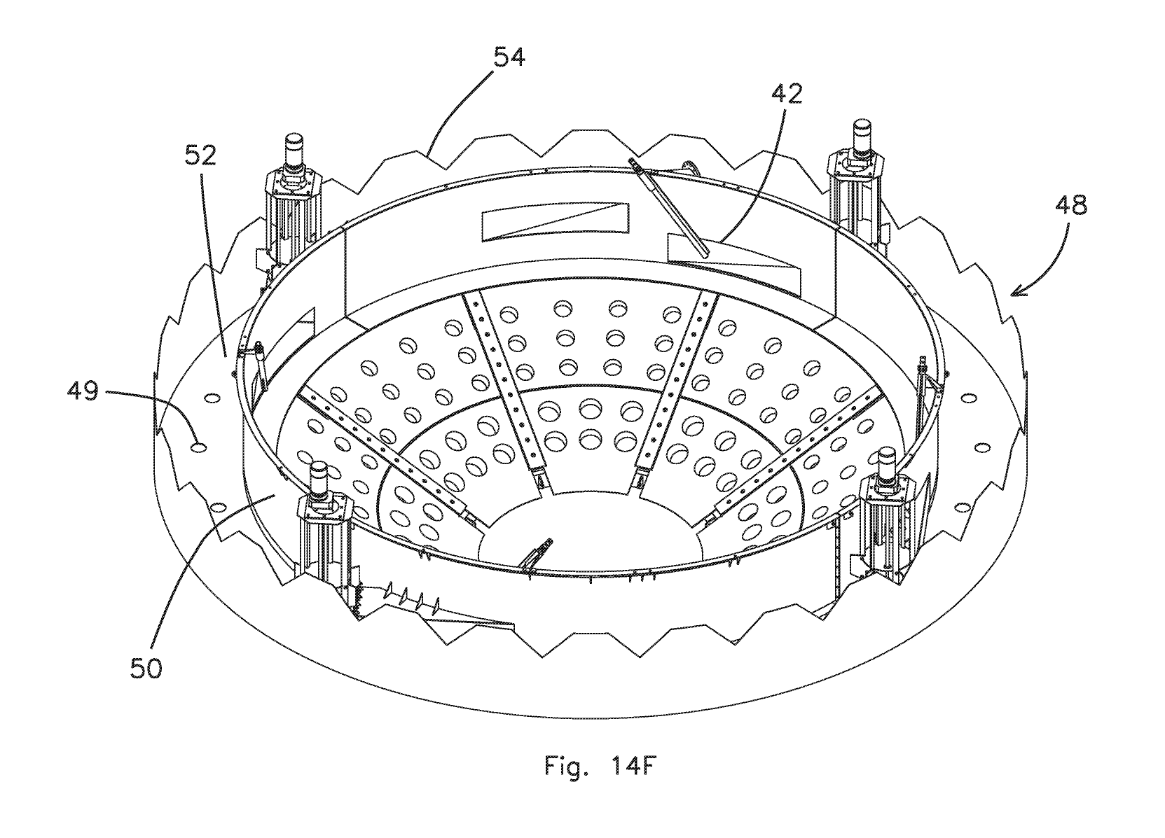

As best illustrated in FIGS. 14A, 14B and 14C, in one embodiment, feed dilution pump 40 can be a horizontal axis pump that is disposed just below a water line of thickener tank 14 so that, when activated, it draws supernatant from thickener tank 14 and passes it into feedwell 12 without having to vertically lift the supernatant. In this embodiment, mounting plate 19 is preferably provided and is attached to discharge tube 17 by sliding the mounting plate into a receiving frame that is fixed to the feedwell body, thus locking the pump in place. This embodiment allows quick and easy fitting of the feed dilution pump module to the feed inlet arrangement without the need for bolting. Mounting bracket 16 preferably comprises a shape and size which receives or otherwise connects to feed dilution pumps 40. For example, in one embodiment, mounting bracket 16 can include feedwell dilution pipe or chute 42, which can include a chute or tubing. In one embodiment, feed dilution pump 40 can itself include pump mounting bracket 16, which can be configured to slide over and down on a receiving portion of mounting bracket 16, thus locating and securing it in the required position with respect to feedwell 12 to allow proper operation. Mounting bracket 16 can optionally include alignment rod or bar 46 that protrudes above the plate and the water level within thickener tank 14. This provides a visual guide when removing or replacing feed dilution pump 40. Of course, tabs, snap locks, bolts, pins, welding, or any other method or apparatus or combinations thereof can be used to connect feed dilution pumps 40 to mounting brackets 16. As best illustrated in FIGS. 14D and 14E, the number and placement of feed dilution pumps 40 can be adjusted to meet a particular need. For example, one, two, three, four, or more feed dilution pumps 40 can be provided and can be arranged at any desired location around a periphery of feedwell 12. The launder preferably collects dilution liquid, typically supernatant, in a radially flow equivalent manner; the launder can have a plurality of overflow weirs or constitute a single weir; the launder can have a plurality of openings on the side or the bottom of the launder to allow inflow or dilution liquid or supernatant fluid.

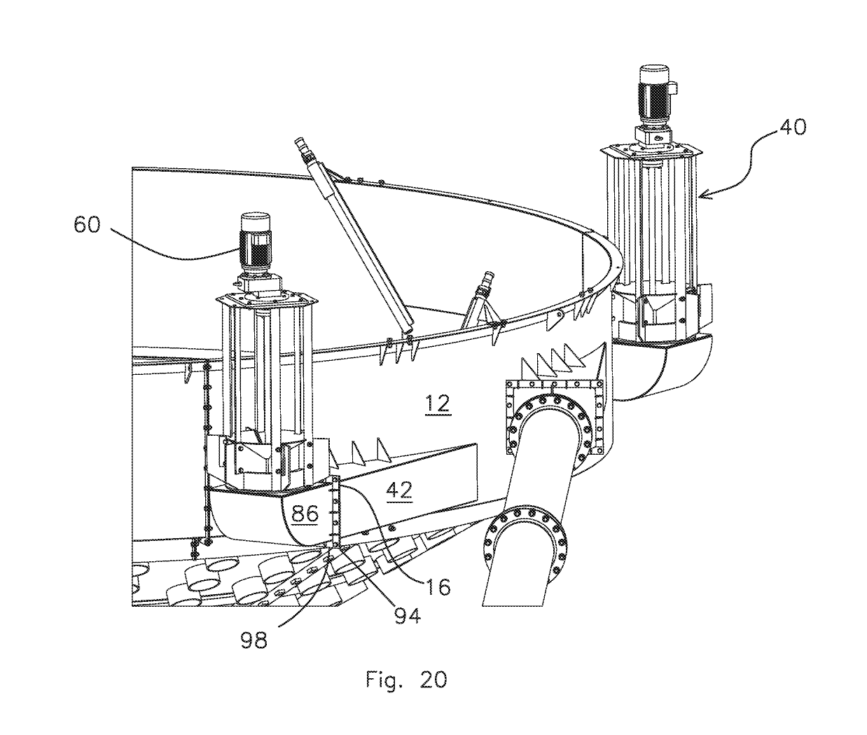

As best illustrated in FIGS. 14F and 20, in one embodiment, feed dilution pump outlet is connected directly to dilution pipe or chute 42 which preferably enters feedwell 12 at a level lower than the incoming feed. This configuration helps to ensure efficient mixing with the incoming solids, thereby creating the maximum solids contact and energy required for mesomixing. In this embodiment, the incoming feed is at a higher solids concentration than the dilution water. As such, the incoming feed naturally wants to migrate downwards, with the dilution water wanting to migrate upwards (due to its lower density). Therefore, these two different density materials must pass through each other vertically, thus resulting in a first mixing action. This embodiment, however, also preferably has the circulation of the material due to the incoming velocity of the feed, to produce a second mixing action. Finally, this embodiment also provides a cyclonic action of the different density materials that try to migrate to either the center or the outside of the feedwell, thus resulting in a third mixing action. Accordingly, embodiments of the present invention preferably provide three different simultaneous mixing actions which produces excellent mixing of the feed, dilution water, and flocculant.

Although less desirable, in one embodiment, mounting brackets 16 are not provided. In this embodiment, feed dilution pumps 40 are instead attached directly to a side of feedwell 12 or feed dilution pumps 40 are instead attached directly to dilution pipe or chute 42. In a preferred embodiment, mounting bracket 16 is easily removable from feedwell 12.

As best illustrated in FIGS. 14E and 14F, in one embodiment collection launder 48 is mounted on outside perimeter wall 50 of the feedwell 12, and preferably includes horizontal plate 52 with a flat or tapered bottom, and outer plate 54 with a flat or notched top section that allows supernatant to enter. Openings 49 are preferably disposed in horizontal plate 52 of launder 48 to allow inflow of supernatant from thickener tank 14 and to allow draining or removal of solids. Check valves 11, in some applications, are preferably fitted to the sides or bottom of launder 48, to assist in regulating the volume of inflow and to prevent liquids or solids from escaping. Horizontal plate 52 of launder 48 can be below, at the same level, or above the water level in thickener tank 14.

In one embodiment, launder 48 can be positioned such that its top is either level with or just below the waterline in thickener tank 14. This permits froth to enter over the top such that launder 48 can capture and manage the froth from thickener tank 14. In this embodiment, the froth is drawn into launder 48 and is passed through impeller 64 (see FIG. 14A), of one or more feed dilution pumps 40 (see FIG. 14D) which preferably shears the froth and dissipates air bubbles and mixes with dilution water. Flocculant can then be injected and mixed thoroughly with the diluted and deaerated froth. The final mixture is then preferably injected beneath the incoming feed and is mixed therewith, thus capturing the solids which are converted to floccules that rotate around the feedwell and are eventually distributed into the thickener.

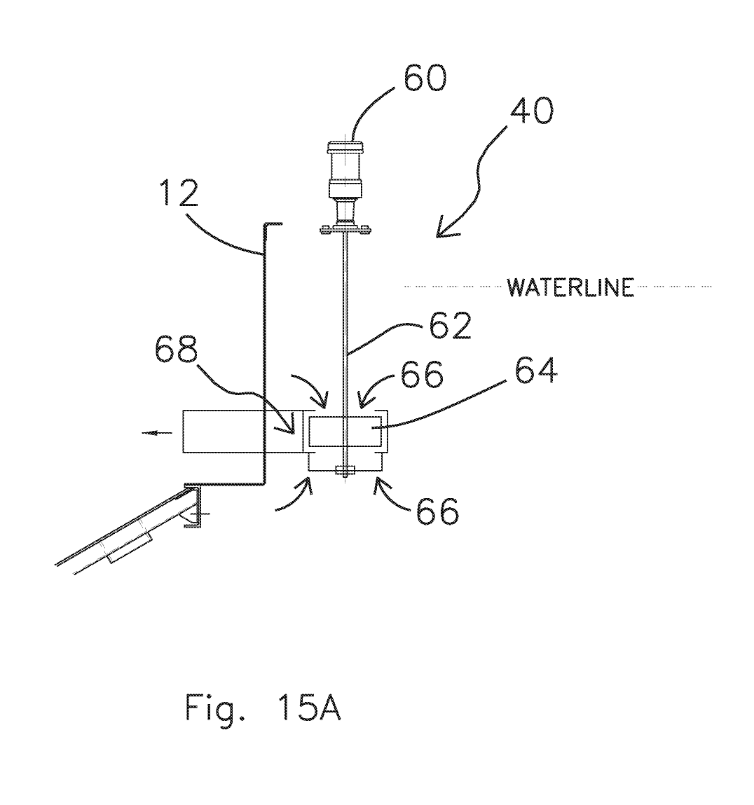

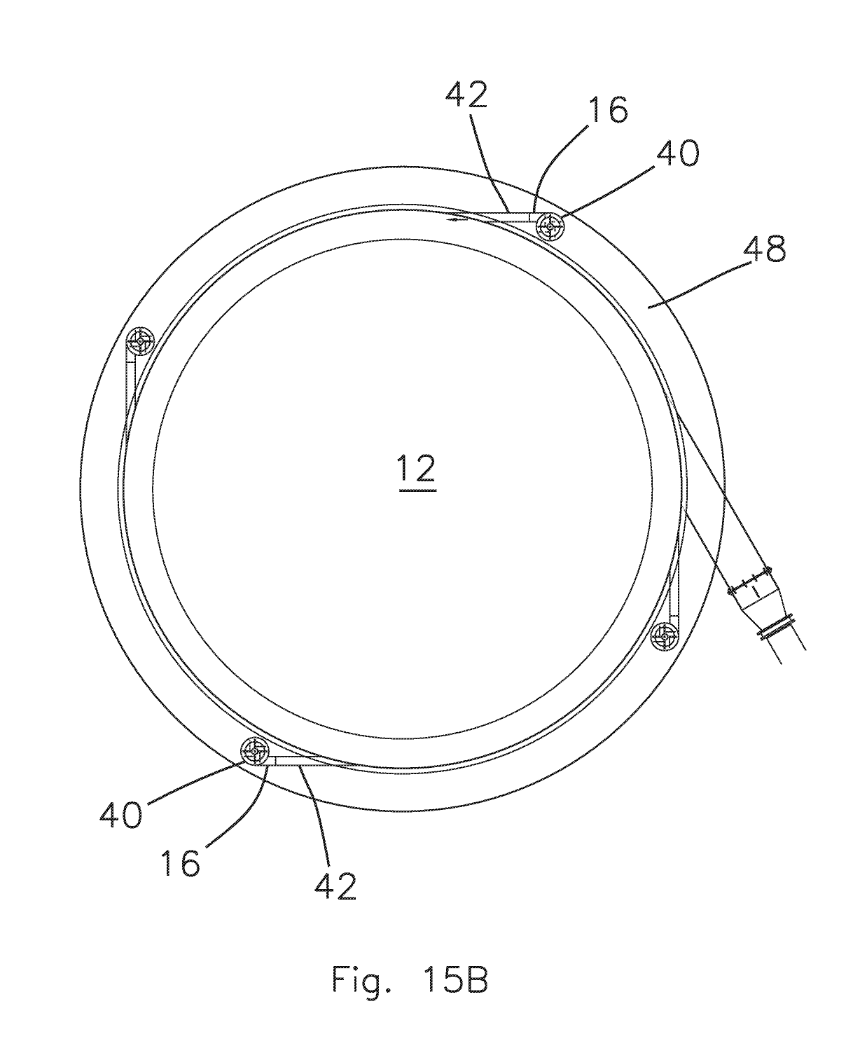

As best illustrated in FIG. 15A, in one embodiment, feed dilution pump 40 can comprise a vertical axis pump. In this embodiment, motor 60 is preferably mounted above a waterline with shaft 62 extending down into the supernatant of thickener tank 14. In this embodiment, supernatant can be drawn into impeller 64 through inlets 66, which can optionally be both above and below impeller 64. The supernatant is then expelled through outlet 68 and into dilution pipe or chute 42 where it enters feedwell 12. FIG. 15B illustrates potential placement of one or more feed dilution pumps of the embodiment illustrated in FIG. 15A.

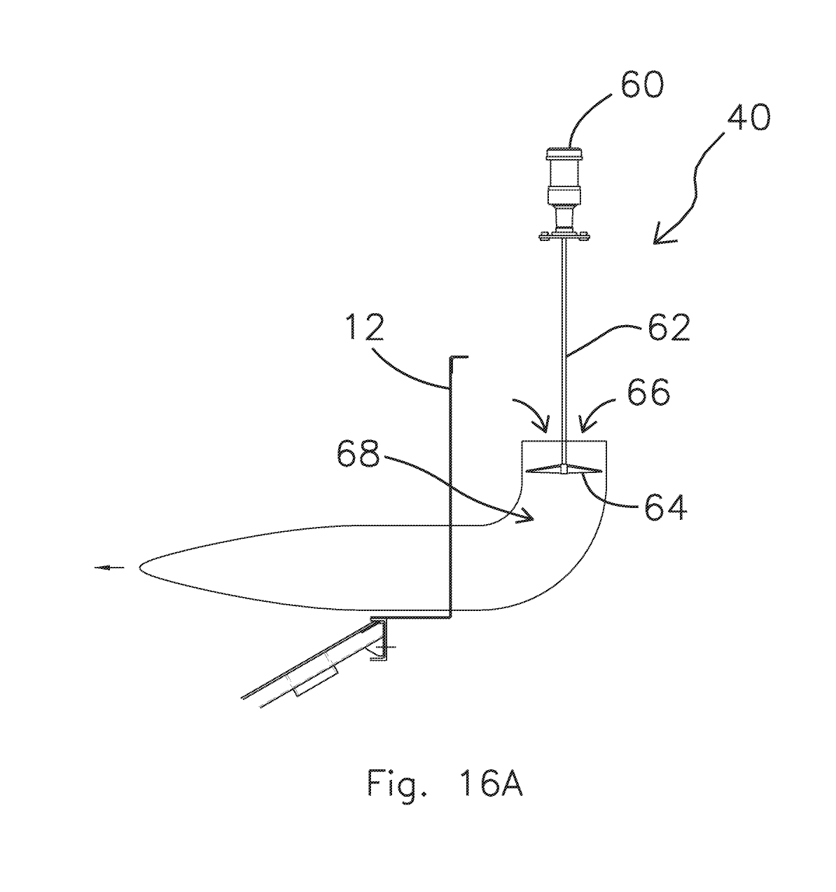

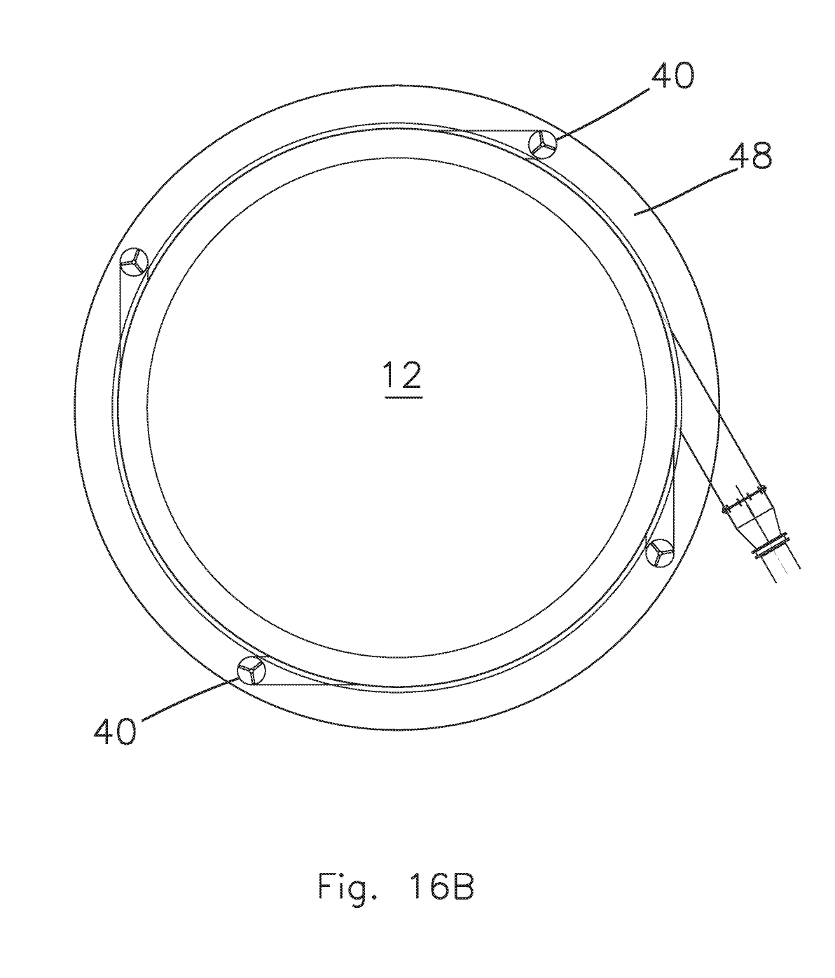

FIG. 16A illustrates an embodiment wherein feed dilution pump 40 again is a vertical axis pump; however, in this embodiment, supernatant is drawn only from inlet 66 located above impeller 64 and not from below impeller 64. FIG. 16B illustrates potential placement of one or more feed dilution pumps of the embodiment illustrated in FIG. 16A.

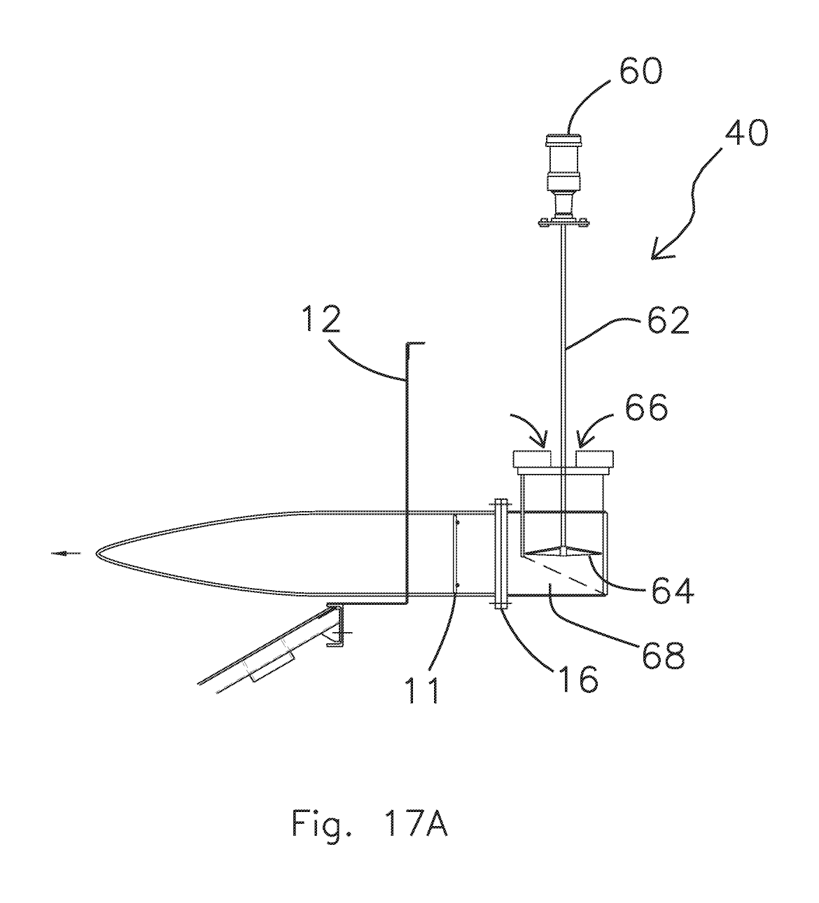

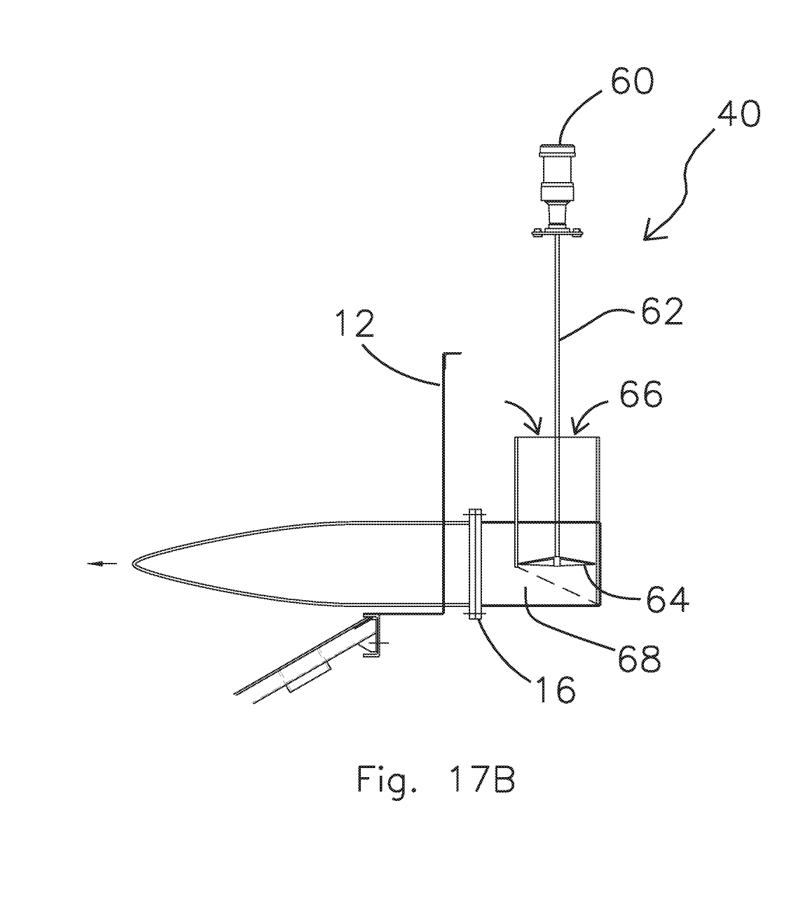

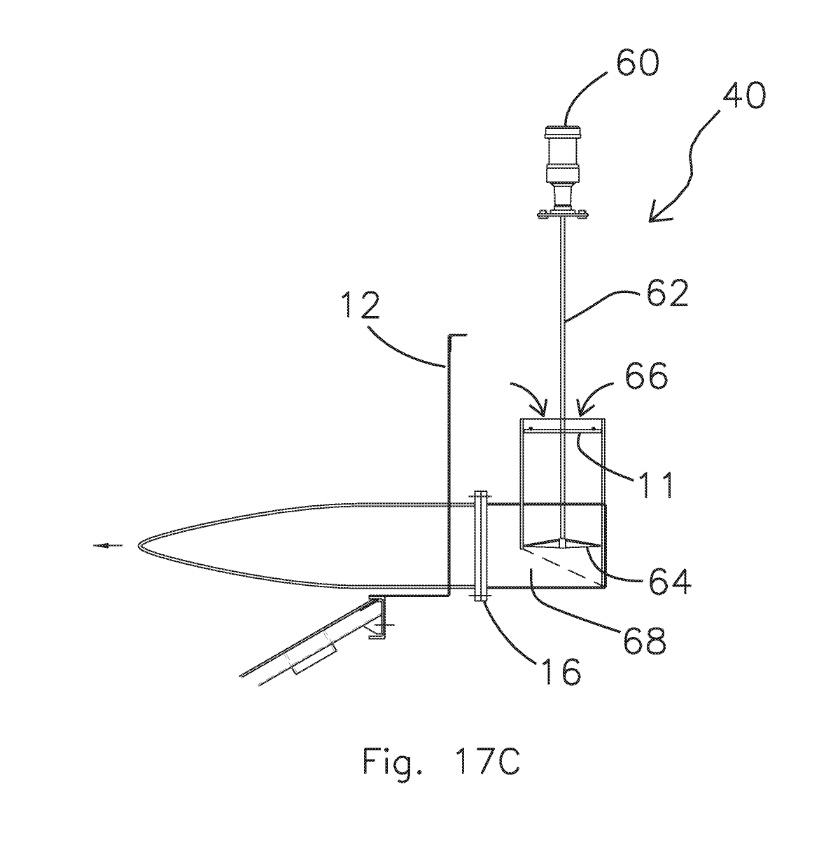

FIGS. 17A, 17B and 17C illustrate embodiments wherein feed dilution pump 40 has vertical shaft 62 and wherein supernatant is drawn from only above impeller 64. However, FIG. 17A illustrates an embodiment wherein check valve 11 is communicably coupled to an outlet of pump 40, whereas FIG. 17B illustrates an embodiment wherein a check valve 11 is not provided. FIG. 17C, however, illustrates an embodiment where check valve 11 is communicably coupled to the inlet side of pump 40. Check valves installed in these embodiments prevent solids from flowing back into thickener tank 14.

In one embodiment, as best illustrated in FIG. 17A, check valve 11 can be disposed in fluid communication with feed dilution pump 40. Optionally, check valve 11 can be incorporated within a housing of feed dilution pump 40. In an alternative embodiment, check valve 11 can be disposed within dilution pipe or chute 42. In a still further embodiment, check valve 11 can be attached to feedwell mounting bracket 16 or to feed dilution pump mounting bracket 16.

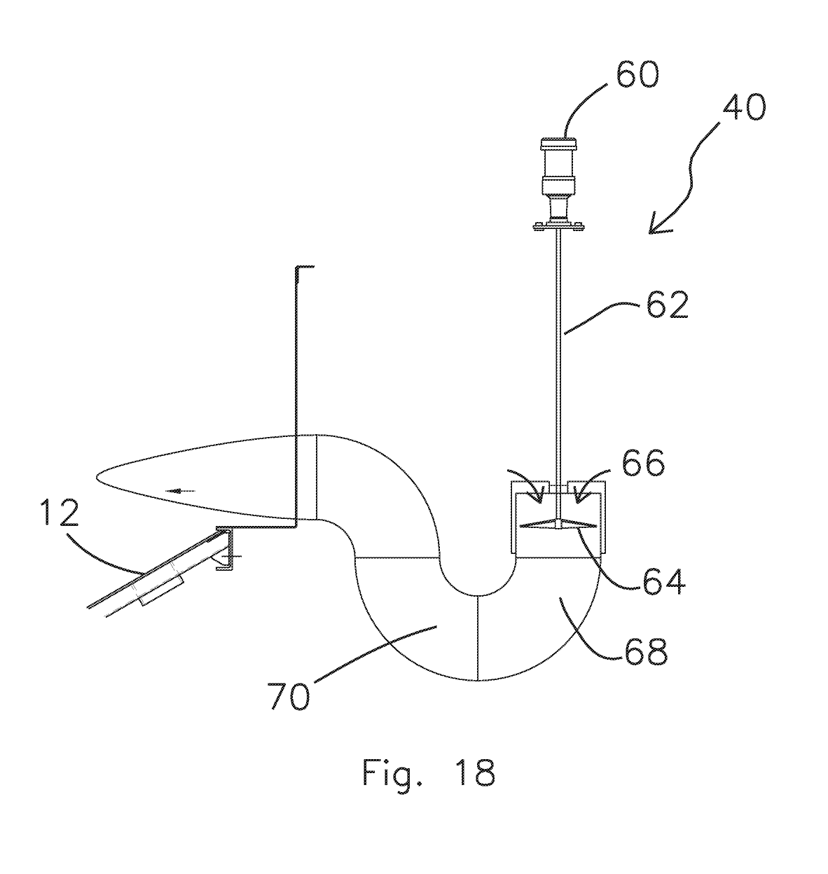

As best illustrated in FIG. 18, in one embodiment, a u-bend 70 can be communicably coupled to an outlet of feed dilution pump 40. The use of an unequal length u-bend provides a larger submergence of the axial flow pump, thus reducing the likelihood of a vortex forming above the axial flow pump.

For embodiments which have both check valve 11 and feed dilution pump 40 in operation, a flow of liquids from outside of feedwell 12 to an inside thereof is permitted because check feed dilution pump 40 preferably draws liquid from a top portion of thickener tank 14 and through check valve 11. Individual check valves 11 of diaphragm 22 preferably bend inward toward a center of feedwell 12, thus providing an open path feed dilution pump 40. If liquid or solids attempts to flow from within feedwell 12 out through check valve 11, check valves 11 of diaphragm 22 are preferably held in a closed position by cross-pieces 26 in outer bezel 24.

Because feedwells are typically round in shape and because the incoming feed stream is typically inserted tangentially into the feedwell, the contents of the feedwell are typically circulating in either a clockwise or counterclockwise direction. By installing one or more feed dilution pumps 40 around the perimeter of feedwell 12 with the flow from each feed dilution pump 40 entering the feedwell tangentially, the feed concentration can be diluted in a controlled manner to a desired concentration. By adjusting the speed of pumps 40 and/or a diameter of a discharge nozzle thereof, the velocity of supernatant that passes through feed dilution pumps 40 and into feedwell 12 can be varied in a controlled manner, thus providing a method of controlling the mixing energy within feedwell 12. In one embodiment, a feed dilution pump 40 can be configured using a DC in-line brushless motor fitted with impeller 64 that can be constructed from any desired material for a particular application, including but not limited to plastic, urethane, brass, aluminum, composites, resins, stainless steel, combinations thereof, and the like.

Optionally, feed dilution pump 40 can be housed within a substantially horizontal pipe, thus forming a pump capable of transferring supernatant from thickener tank 14 into feedwell 12 without having to provide significant vertical lift to the supernatant. For this method, feed dilution pump 40 is preferably configured such that it does not have to lift supernatant to pass it from thickener tank 14 into feedwell 12.

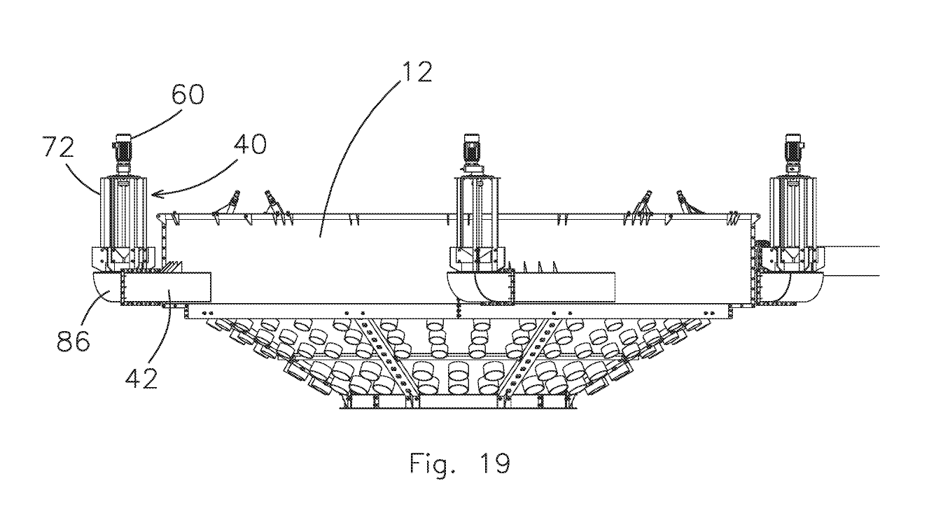

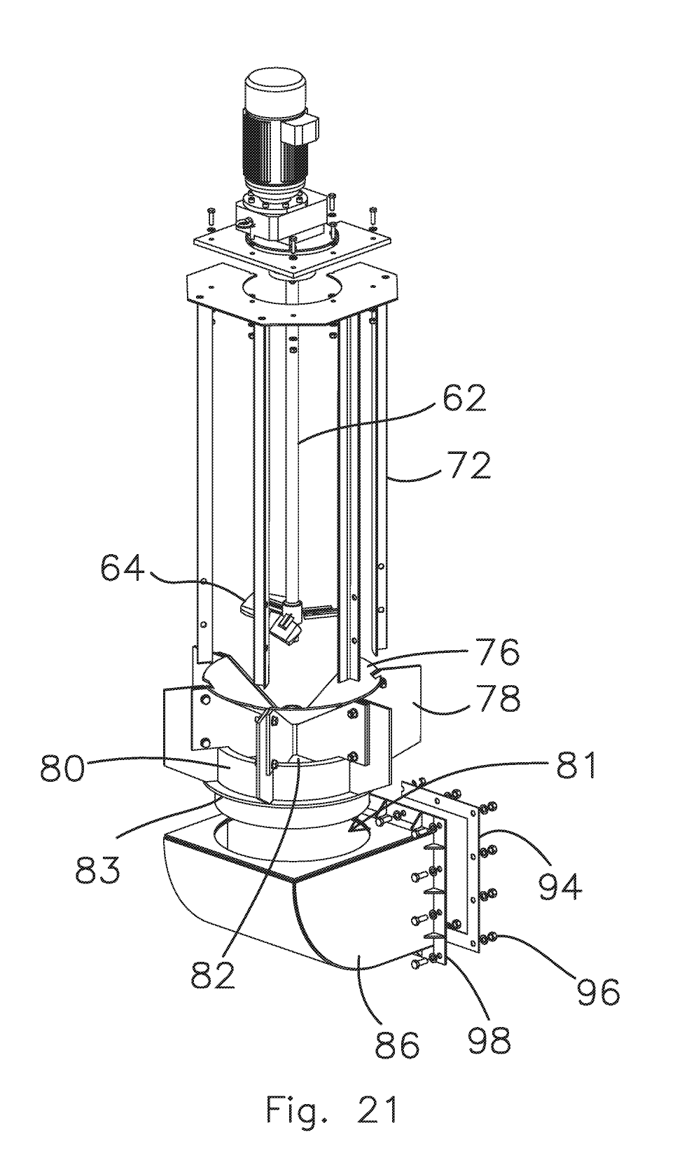

Referring now to FIGS. 19-23, in one embodiment, motor 60 of vertical axis feed dilution pump 40 can be held a desired distance above impeller 64 via a plurality of standoffs 72. Although standoffs 72 can be formed from any material sufficiently rigid and strong enough to hold motor 60 at a desired location, in one embodiment, standoffs 72 are preferably formed from elongated material such as angle iron although the material itself need not necessarily comprise any iron. The shape of standoffs 72 thus help to create a drag force in the supernatant liquid around shaft 62, thereby helping to inhibit the formation of a vortex. To further reduce the required depth of impeller 64 below a waterline of a thickener tank, induction cone 76 and a plurality of vortex breakers 78 are preferably disposed around shaft 62 just above impeller 64.

Ring 80 is preferably disposed around a lower portion of vortex breakers and preferably extends into opening 81, which is preferably disposed on a top portion of induction body 86. In this preferred embodiment, the entire pump dilution module including pump 40 are easily removable from above. In one embodiment, induction body 86 most preferably forms a swept 90-degree fitting that connects feed dilution pump 40 to feedwell 12 (or feedwell dilution pipe or chute 42 if provided).

Ring 80 is preferably disposed below cone 76 and preferably has vortex breakers 78 extending radially across a top end portion of ring 80, thus forming a plurality of inlet openings 82 between vortex breakers 78 below cone 76. Although ring 80 is most preferably circular in shape, the circular shape is not essential to the operation of the invention and thus desirable results can be achieved when ring 80 comprises other shapes, including but not limited to square, triangular, hexagonal, octagonal, star-shapes, combinations thereof, and the like. Opening 81 of induction body 86 preferably comprises a shape which is at least substantially similar to the outer shape of a selected ring 80. Impeller 64 is preferably disposed within or at least substantially within ring 80. Thus, ring 80 preferably forms a housing for impeller 64.

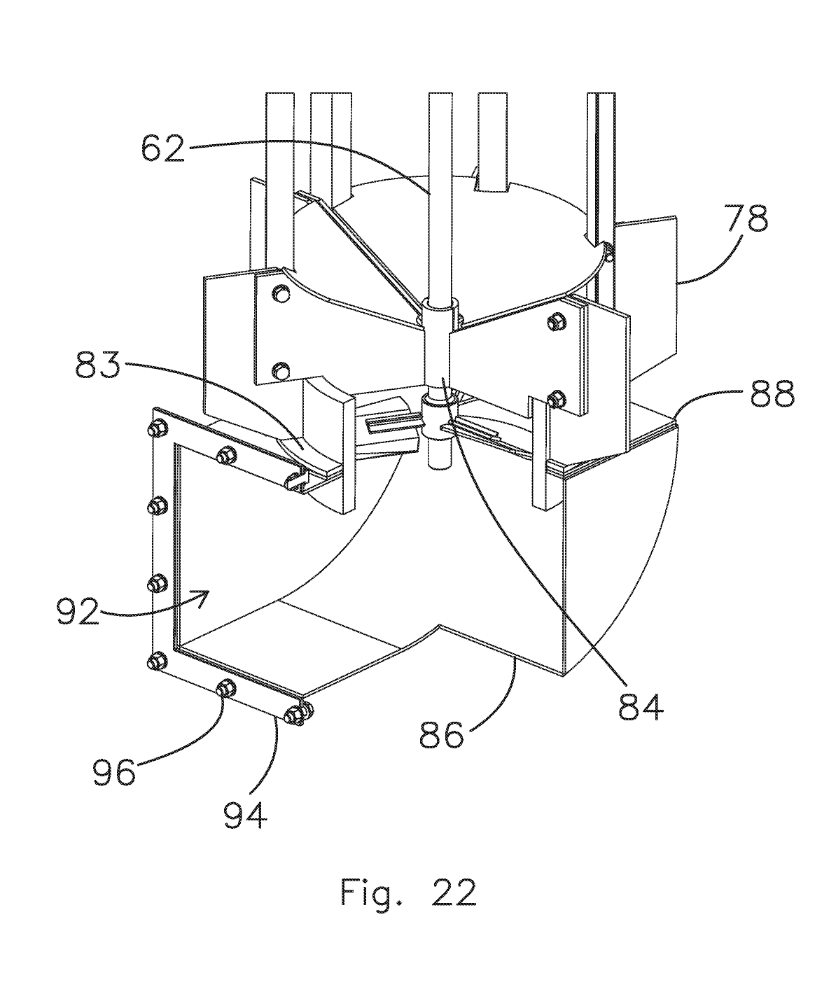

Most preferably, bottom plate 83 encircles ring 80 at a distance above a bottom surface of ring 80, thus allowing ring 80 to extend down below plate 83. Induction body 86 preferably comprises gasket material 88 (see FIG. 22) disposed on its top surface for the purpose of sealing. Ring 80 preferably comprises outside dimensions which fit snugly inside of opening 81. As such, to install feed dilution pump 40 onto induction body 86, a user need only slide ring 80 down into opening 81 of induction body until a bottom of plate 83 comes to rest on top of gasket material 88, thus supporting feed dilution pump 40. Because the bottom surface of bottom plate 83 is preferably substantially flat, a seal is formed between feed dilution pump 40 and induction body 86. Pump impeller 64 and shaft 62 preferably pass through a steady bearing or bushing 84 located in the center of vortex breakers 78. Steady bearing or bushing 84 stabilizes shaft 62 and prevents it from moving in a radial direction or allowing impeller 64 to accidently contact ring 80. Because feed dilution pump 40 can be simply slid down into position, embodiments of the present invention thus provide a modular design that allows the entirety of feed dilution pump assembly or module 40 to be easily lifted out as a single component while thickener tank 14 and feedwell 12 are still operating. As such, another feed dilution pump 40 can quickly and easily be swapped in place of an already installed feed dilution pump, thus reducing down-time and enhancing the efficiency of an overall operation. The replacement of the smaller pumps can be done on-line, while the thickener is in operation. This is possible as the units are relatively small and the temporary loss of flowrate by the removal of the unit will not impact the overall performance of the thickener too extensively. The invention allows for the use of a plurality of pumps so that pumps are easily manhandled by a user directly.

Induction body 86 preferably comprises mounting plate 98 and attaches to mounting bracket 16 of feedwell 12 (or to feedwell dilution pipe or chute 42 if provided) via one or more fasteners 96. Preferably, gasket 94 is disposed between mounting plate 98 and mounting bracket 16 to form a tight seal.

In operation, when a vortex attempts to form, it is preferably forced outward away from shaft 62 by cone 76. Vortex breakers 78 then create drag in the supernatant liquid which inhibit rotation and thereby inhibit the formation of a vortex. By inhibiting the formation of a vortex, the necessary submergence of impeller 64 is thus reduced. This enables feed dilution pump 40 to be placed at a shallower operating depth within thickener tank 14, thereby drawing supernatant liquid from the very top portion of thickener tank 14. As such, a user is afforded more flexibility with regard to the effective depth of feed dilution pump 40, head differential, and overall positioning of feed dilution pump 40 and the inlets of feedwell 12 or of feedwell 12 with respect to a thickener tank.

In one embodiment, feed dilution pump 40 is held in place without any fasteners. In one embodiment, a user can slide feed dilution pump up and out of its position without having to manipulate any nuts or bolts. In one embodiment, feed dilution pump 40 can be removed and replaced without taking apart or putting together any nuts and bolts. In one embodiment, one or more feed dilution pumps 40 can be controlled by a system which has, as an input, a flowmeter sensor or a sensor that monitors density.

An embodiment of the present invention relates to a dilution port check valve that is round, triangular, square or rectangular and has a plurality of pie-shaped, rectangular, square or triangular segments. The segments can be either held in the center and can flex at the circumference, or segments are held at the outer circumference and can flex at the center, or the segments can be held on vertices (including but not limited to radially, vertically, horizontally or any other orientation) and can flex away from the vertices. Optionally, the segments can have support or braces on one side to allow flexing in only one direction, the flow direction, and preventing flow in the other direction through a check valve and closing against support or bracing. An embodiment of the present invention also relates to round, triangular, square or rectangular dilution port check valves which can comprise a variety of sizes. The round, triangular, square or rectangular dilution ports can be placed by themselves or in conjunction with a dilution pump, either placed before or after the pump. The round, triangular, square or rectangular dilution ports can direct the flow in any direction into the feedwell, however, a tangential direction is most preferred.

Although the drawings illustrate embodiments of the present invention wherein an impeller is directly connected to an output of a motor, in one embodiment, a gearbox or other energy transferring apparatus can be coupled between the motor and the impeller and will provide desirable results.

Whether the dilution pump is of a vertical, angled or horizontal orientation, the addition of baffles in line with the axial flow, along the length of the tube segment of the impeller, and as a minimum before and after the impeller, are used to streamline the flow, thereby improving the pumping efficiency of the impeller.

Note that in the specification and claims, “about” or “approximately” means within twenty percent (20%) of the numerical amount cited.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and and/or reconfiguration of their relationships with one another.

What is claimed is:

1. A dilution port check valve comprising:
a valve housing, said valve housing configured to attach to a feedwell;
an inner bezel;
an outer bezel; and
a diaphragm, said diaphragm comprising at least one check valve disposed therein and said diaphragm disposed between said inner bezel and said outer bezel.

2. The dilution port check valve of claim 1 further comprising a plurality of check valves disposed in said diaphragm.

3. The dilution port check valve of claim 2 wherein each of said plurality of check valves comprises an at least substantially rectangular shape,

4. The dilution port check valve of claim 1 wherein said valve housing comprises a shape that when attached to the feedwell causes fluid to enter the feedwell tangentially thereto.

5. The dilution port check valve of claim 1 wherein said diaphragm is formed from a sheet of material.

6. The dilution port check valve of claim 1 wherein said diaphragm comprises a flexible material.

7. The dilution port check valve of claim 1 wherein said outer bezel comprises at least one cross-piece.

8. The dilution port check valve of claim 1 wherein said outer bezel comprises a plurality of cross-pieces.

9. The dilution port check valve of claim 1 wherein said valve housing comprises a dilution port mounting bracket, such that said valve housing is configured to attach to the feedwell via said dilution port mounting bracket.

10. The dilution port check valve of claim 1 wherein said at least one check valve is arranged such that when said dilution port check valve is attached to the feedwell, supernatant liquid passing through said dilution port check valve is directed into the feedwell.

11. A feed dilution pump comprising:
a pump,
an inlet of said pump disposed within a thickener tank;
an outlet of said pump communicably coupled to an internal area of a feedwell; and
said pump configured and disposed so that it moves supernatant liquid from a thickener tank to the feedwell without lifting the supernatant liquid more than six inches.

12. The feed dilution pump of claim 11 wherein said pump comprises a vertical axis pump.

13. The feed dilution pump of claim 11 wherein said pump comprises a horizontal axis pump.

14. The feed dilution pump of claim 11 further comprising a check valve disposed in fluid communication with said pump at a location between an impeller and the internal area of the feedwell or on an inlet side of an impeller of said feed dilution pump.

15. The feed dilution pump of claim 11 wherein said outlet of said pump is coupled to a pipe that is connected to a feedwell.

16. The feed dilution pump of claim 11 further comprising a direct current powered motor.

17. The feed dilution pump of claim 16 wherein said direct current powered motor is sealed and is directly coupled to an impeller of said feed dilution pump.

18. A method for automatically controlling entry of supernatant liquid into a feedwell, the method comprising:
attaching a dilution port check valve to the feedwell;
allowing one or more check valves of a diaphragm to swing inward toward a center of the feedwell to permit a flow of the supernatant liquid into the feedwell; and
inhibiting supernatant liquid from flowing out of the feedwell by preventing the one or more check valves of the diaphragm from opening in a direction away from the feedwell by stopping them with one or more cross-pieces of an outer bezel.

19. The method of claim 18 wherein attaching a dilution port check valve to the feedwell comprises attaching a dilution port check valve to the feedwell with a bracket.

20. A method for providing feed dilution comprising:
disposing a plurality of feed dilution pumps about a feedwell;
arranging the plurality of feed dilution pumps such that outflow from each feed dilution pump enters the feedwell at least substantially tangentially thereto or at substantially a right angle thereto; and
configuring the plurality of feed dilution pumps around the feedwell to provide feed dilution equally around a circumference of the feedwell.

21. The method for providing feed dilution of claim 20 further comprising disposing a pipe or chute between each of the feed dilution pumps and the feedwell.

22. The method for providing feed dilution of claim 20 further comprising attaching the feed dilution pumps to the feedwell via sliding brackets.

23. The method for providing feed dilution of claim 20 further comprising disposing a launder at least partially around the feedwell.

24. The method for providing feed dilution of claim 23 wherein disposing the launder comprises disposing an open top launder at least partially around the feedwell.

25. The method for providing feed dilution of claim 23 further comprising disposing a plurality of openings on an outer-circumference side of the launder.

26. The method for providing feed dilution of claim 23 further comprising disposing a plurality of openings on a bottom side of the launder.

27. The method for providing feed dilution of claim 20 further comprising adjusting mixing energy of the feedwell by adjusting the speed of one or more of the feed dilution pumps.

28. The method for providing feed dilution of claim 20 further comprising positioning the dilution pumps such that the outflow thereof is injected below a level of an incoming feed.
